(19) United States
(12) Patent Application Publication
(10) Pub. No.: US 2012/0016128 A1
(43) Pub. Date: Jan. 19, 2012

(54) Rhodamine lactone phosphoramidites and polymers

(76) Inventors: Zhenjun Diwu, Sunnyvale, CA (US); Haitao Guo, Sunnyvale, CA (US)

(21) Appl. No.: 13/135,178

(22) Filed: Jun. 27, 2011

Related U.S. Application Data
(60) Provisional application No. 61/399,715, filed on Jul. 16, 2010.

(51) Int. Cl. C07F 7/02; C07F 9/6596; C07F 9/6561

(52) U.S. Cl. 546/14; 549/220; 546/15; 549/214; 549/5

(57) ABSTRACT

The present invention provides rhodamine lactone phosphoramidites and polymer compositions, methods for making these phosphoramidites and polymer compositions, and methods for using these phosphoramidites and polymer compositions for labeling oligonucleotides. In particular, the present invention provides compositions and methods for labeling the 3′- and 5′-end of oligonucleotides during synthesis of the oligonucleotides.

This application claims the benefit of priority from U.S. Provisional Patent Application Ser. No. 61/399,715, filed Jul. 16, 2010, the disclosure of which is explicitly incorporated by reference herein.

### FIELD OF THE INVENTION

The present invention provides rhodamine lactone phosphoramidites and polymer compositions, methods for making these phosphoramidites and polymer compositions, and methods for using these phosphoramidites and polymer compositions for labeling oligonucleotides. In particular, the present invention provides compositions and methods for labeling the 3′- and 5′-end of oligonucleotides during synthesis of the oligonucleotides.

### BACKGROUND OF THE INVENTION

Labeling of nucleic acids and/or oligonucleotides, with reporter molecules is important in many areas of chemical and biological research. Due to the fact that single stranded oligonucleotides hybridize with complementary single or double stranded oligonucleotides, labeled oligonucleotides can be used as probes in cloning procedures, blotting procedures such as Northern blot analysis, and in situ hybridization procedures. Additionally, labeled oligonucleotides can be used in conjunction with oligonucleotide amplification procedures such as the Polymerase Chain Reaction (PCR), Strand Displacement Amplification (SDA), Nucleic Acid Sequence-Based Amplification (NASBA), and Ligase Chain Reaction (LCR) to detect the presence of amplified oligonucleotides. Thus, labeled oligonucleotides are used for both qualitative and quantitative analyses of target nucleic acid molecules.

Oligonucleotides can be labeled with several different types of reporter molecules. For example, oligonucleotides can be labeled with radioisotopes such as ³²P, ³H, ¹⁴C, ³⁵S, ¹²⁵I, or ¹³¹I. Oligonucleotides may also be labeled with non-isotopic labels such as fluorescein, biotin, digoxigenin, and alkaline phosphatase. However, when using labeled oligonucleotides for the identification and quantification of target nucleic acids, fluorescent labels have been favored as they provide a sensitive, non-radioactive mean for the detection of probe hybridization. The fluorescent labels may be used alone, or in conjunction with quenching dyes in fluorescence energy transfer reactions. Fluorescence resonance energy transfer (FRET) occurs between a donor fluorophore and an acceptor or quenching dye when the absorption spectrum of the acceptor dye overlaps the emission spectrum of the donor fluorophore, and the two dyes are in close proximity. Upon excitation of the donor molecule the energy emitted from the donor molecule is transferred to the neighboring acceptor molecule which accepts and quenches this energy. This acceptance of the energy by the acceptor results in quenching of donor fluorescence. The overall effect of such energy transfer is that the emission of the donor is not detected until the donor and acceptor are separated, for example upon hybridization of a labeled probe to a target nucleotide.

In practice, the donor and acceptor molecules may either reside on complementary oligonucleotides or on a single oligonucleotide. When incorporated into complementary oligonucleotides, quenching occurs upon hybridization of the separately labeled oligonucleotides. In contrast, when the donor and acceptor are linked to a single oligonucleotide, hybridization to the target oligonucleotide usually results in reduced quenching due to an increased distance between the donor and acceptor which decreases the effect of energy transfer. Reduced quenching is observed as increased ability to detect the energy emitted from the donor. For example, an acceptor and donor may be linked to the ends of a self-complementary oligonucleotide such that under non-hybridizing conditions a hairpin is formed which brings the acceptor and donor into close proximity and causes quenching. Hybridization of the self-complementary oligonucleotide results in linearization of the hairpin and reduced quenching. Additionally, to further contribute to the change in fluorescence upon hybridization, a restriction endonuclease site may be placed between the acceptor and donor dyes such that the site is only cleavable in the presence of target binding.

When employing fluorescent dyes for labeling biological molecules, there are many constraints on the choice of the fluorescent dye. One constraint is the absorption and emission characteristics of the fluorescent dye, since many ligands, receptors, and materials in the sample under test, e.g., blood, urine, cerebrospinal fluid, will fluoresce and interfere with an accurate determination of the fluorescence of the fluorescent label. This phenomenon is called autofluorescence or background fluorescence. Another consideration is the ability to conjugate the fluorescent dye to ligands and receptors and other biological and non-biological materials and the effect of such conjugation on the fluorescent dye. In many situations, conjugation to another molecule may result in a substantial change in the fluorescent characteristics of the fluorescent dye and, in some cases, substantially destroy or reduce the quantum efficiency of the fluorescent dye. It is also possible that conjugation with the fluorescent dye will inactivate the function of the molecule that is labeled. A third consideration is the quantum efficiency of the fluorescent dyes which should be high for sensitive detection. A fourth consideration is the light absorbing capability, or extinction coefficient, of the fluorescent dyes, which should also be as large as possible. Also of concern is whether the fluorescent molecules will interact with each other when in close proximity, resulting in self-quenching. An additional concern is whether there is non-specific binding of the fluorescent dyes to other compounds or container walls, either by themselves or in conjunction with the compound to which the fluorescent dye is conjugated.

The applicability and value of the methods indicated above are closely tied to the availability of suitable fluorescent compounds. In particular, there is a need for fluorescent substances that emit in the longer wavelength region (yellow to near infrared), since excitation of these chromophores produces less autofluorescence and also multiple chromophores fluorescing at different wavelengths can be analyzed simultaneously if the full visible and near infrared regions of the spectrum can be utilized. Xanthene dyes are the most common class of fluorescent probes that are predominantly used for labeling biological molecules, e.g., U.S. Pat. No. 7,704,284 to Eliu, et al. (2010); U.S. Pat. No. 7,491,830 to Lam, et al. (2009); U.S. Pat. No. 7,344,701 to Reddington, et al. (2008); U.S. Pat. No. 6,229,055 to Klaubert, et al. (2001); U.S. Pat. No. 6,130,101 to Mao, et al. (2000).

Fluorescein phosphormidites are widely used for preparing fluorescent oligonucleotides, e.g., U.S. Pat. No. 6,875,850 to Heindl, et al. (2005); Eur. Pat. No. 1,186,613 to Heindl, et al. (2002); Chinese Pat. Appl. No. 1,600,816 to Zhang, et al., (2003); Dubey, et al., Bioconjugate Chem. 9, 627 (1998); Adamczyk, et al., J. Org. Chem. 65, 596 (2000). Although fluorescein-labeled nucleotides are extremely useful emitter in the green fluorescence region, the background autofluorescence of the biological samples generated by excitation at fluorescein absorption wavelengths limits the detection sensitivity for certain molecular diagnostics, immunoassays and cell analysis systems. In addition, the pH sensitivity of fluorescein dyes make certain fluorescein probes undesirable for assays that require low pH environments. The red fluorescent rhodamine labels have proved to be more effective than fluoresceins. Unfortunately the existing rhodamine phosphoramidites are extremely unstable and difficult to be used for labeling oligonucleotides. In consequence, the commercial rhodamine phosphormidites have very low purity, making the rhodamine labeling process much less effective.

### BRIEF DESCRIPTION OF THE DRAWINGS

FIG. 1. Synthesis of a rhodamine lactone that has a phosphoramidite moiety.

FIG. 2. Synthesis of a rhodol lactone that has a phosphoramidite moiety.

FIG. 3. Synthesis of a rhodamine lactone that has a CPG moiety.

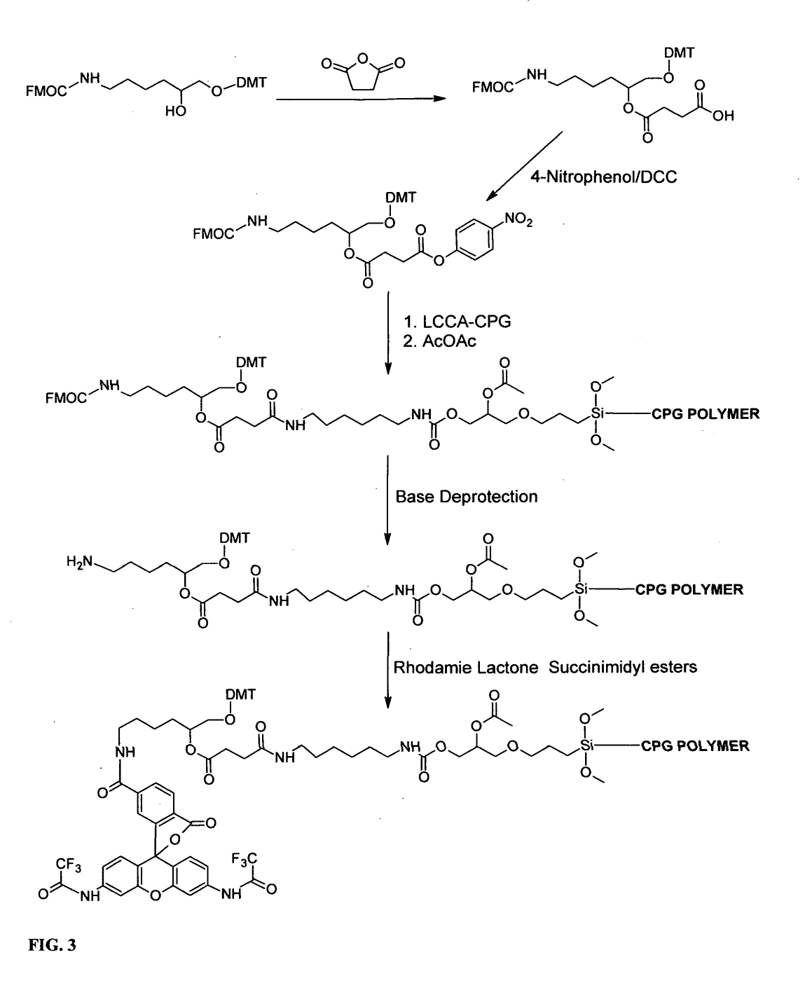

FIG. 4. Synthesis of a rhodol lactone that has a CPG moiety.

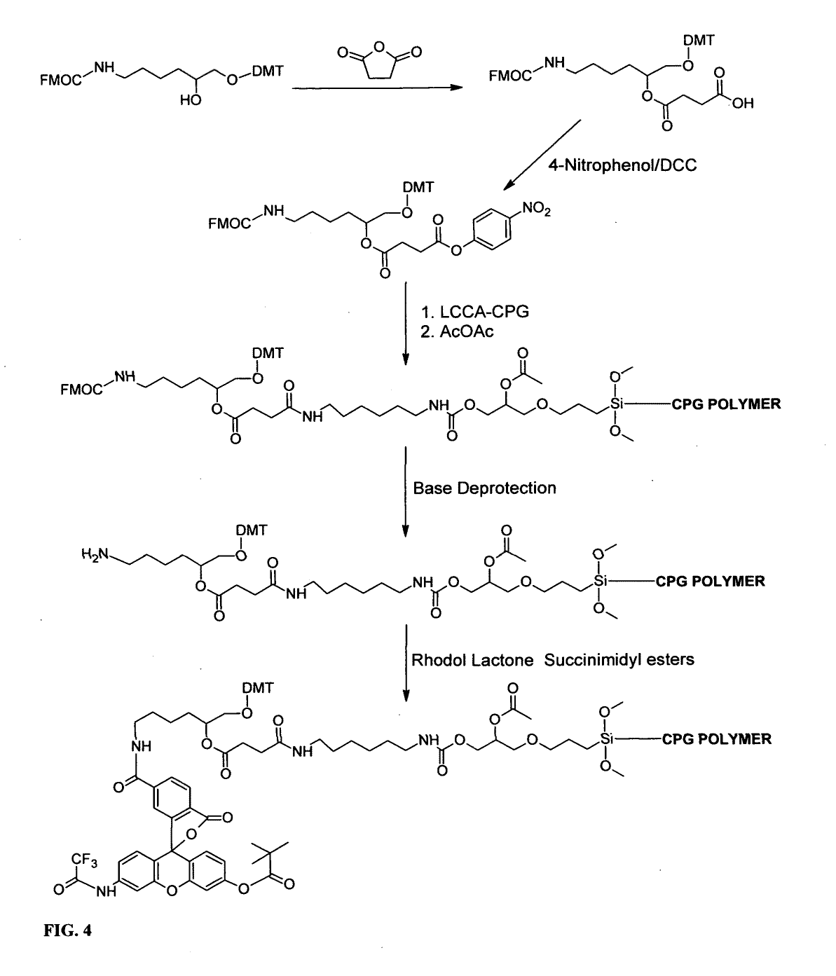

FIG. 5. Stability comparison of TAMRA phosphoramidite with Compound 4. TAMRA phosphoramidite (AAT Bioquest) and Compound 4 are stored at room temperature under anhydrous conditions for 14 days. HPLC is used to monitor the purities of TAMRA phosphoramidite (AAT Bioquest) and Compound 4 with reverse phase C3 column in combination with an eluting system of 90% acetonitrile/0.1M triethylammonium acetate. The HPLC signals are monitored at 254 nm. The samples are taken at Day 0 and Day 14.

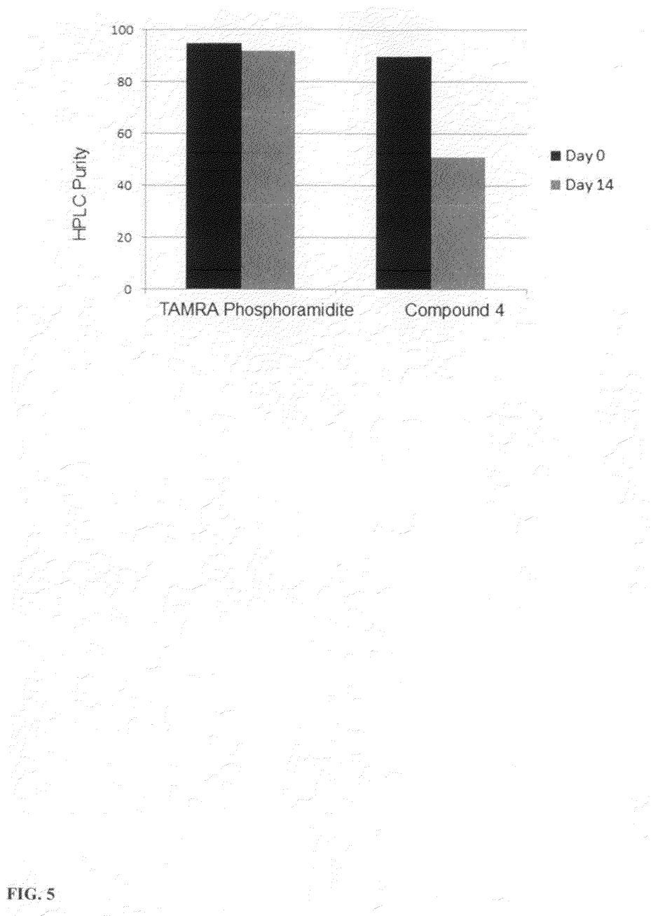

### SUMMARY OF THE INVENTION AND DESCRIPTION OF PREFERRED EMBODIMENTS

We discovered that the low stability of existing rhodamine phosphoramidites might result from the intramolecular redox reaction of reductive phosphoramidite moiety and positively charged oxidative rhodamine chromophore (quinoid form). This redox reaction can be eliminated by locking rhodamine chromophores in the form of lactone with two protection groups as shown below:

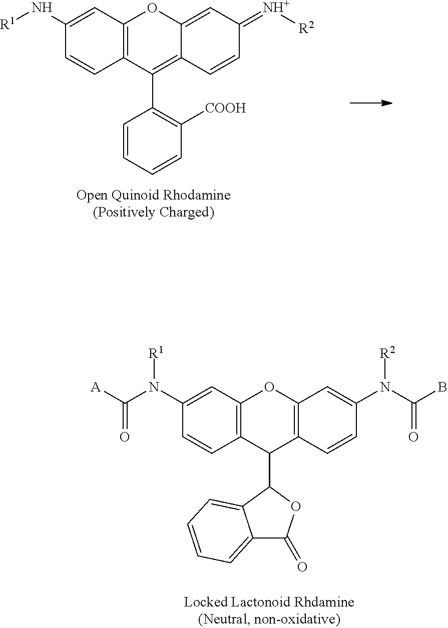

The rhodamine lactone phosphoramidites unexpectedly mitigate all the problems discussed in the background section, including the low stability, low solubility in acetonitrile, low purity and short lifetime of the existing quinoid rhodamines, e.g., U.S. Pat. No. 6,750,357 to Chiarello, et al.; U.S. Pat. No. 5,231,191 to Woo, et al.; U.S. Pat. No. 7,344,701 to Reddington, et. al. The dyes of the invention typically exhibit absorbance maxima between about 500 nm and 800 nm, so these dyes can be selected to match the principal emission lines of the mercury arc lamp (546 nm), frequency-doubled Nd-Yag laser (532 nm), Kr-ion laser (568 nm and 647 nm), HeNe laser (543 nm, 594 nm, and 633 nm) or long-wavelength laser diodes (especially 635 nm and longer). Some dyes of the invention exhibit very long wavelength excitation (at least 640 nm, but some greater than about 730 nm) and emission bands (at least 665 nm, and some greater than about 750 nm), so they are particularly useful for samples that are transparent to infrared wavelengths.

The present invention comprises rhodamine lactone phosphoramidites and their conjugates. The dyes and dye conjugates are used to locate or detect the interaction or presence of analytes or ligands in a sample. Kits incorporating such dyes or dye conjugates facilitate their use in such methods.

The dyes of the invention typically have Formula I (rhodamine) or Formula II (rhodol):

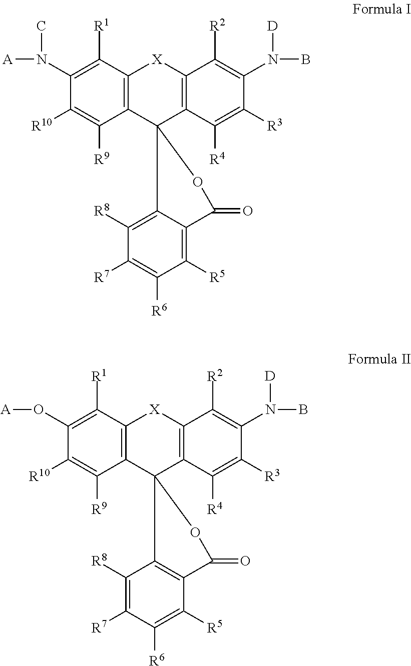

wherein A and B are independently C(═O)R¹¹, C(═O)NHR¹¹, C(═O)OR¹¹, or S(═O)₂R¹¹; C and D are independently a hydrogen, an alkyl, a halogenated alkyl, a cycloalkyl, an aryl, a heteroaryl, an arylalkyl, an alkoxyalkyl or a polyethyleneglycol (PEG); X is O, S, Se, NR¹³, CR¹³R¹⁴ or SiR¹³R¹⁴; R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that at least one of C, D, R¹ to R¹⁰, R¹³ and R¹⁴ contains a phosphoramidite moiety as shown below:

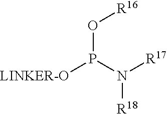

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG); R¹⁶ to R¹⁸ are independently an alkyl, a halogenated alkyl, a cyanoalkyl, a cycloalkyl, an arylalkyl, an alkoxyalkyl or a polyethyleneglycol (PEG).

The dyes of the invention comprise a rhodamine lactone dye that contains: 1) a phosphoramdite group; and 2) a lactone ring. In one embodiment of the invention, protection Moieties A and B are different groups. In another embodiment, protection Moieties A and B are the same group. Preferred compounds have one phosphoramidite group. Selection of Moieties C, D and X may also significantly affect the dye's absorption and fluorescence emission properties. C and D are optionally the same or different, and spectral properties of the resulting dye may be tuned by careful selection of C, D and X. Incorporation of one or more non-hydrogen substituents on the fused rings can be used to fine tune the absorption and emission spectrum of the resulting dye. The dyes of the invention are substituted by one or more phosphoramidite group or conjugated substances as described below. In a preferred embodiment, the dye of the invention is substituted by only one phosphoramidite.

Another preferred embodiment is a compound of Formula III:

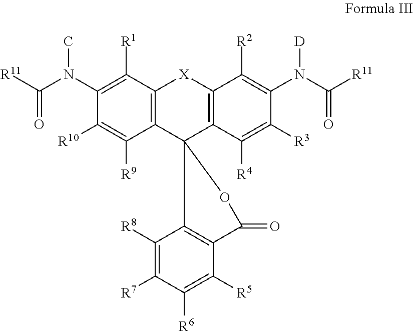

wherein C and D are independently a hydrogen, an alkyl, a halogenated alkyl, a cycloalkyl, an aryl, an arylalkyl, an alkoxyalkyl or a polyethyleneglycol (PEG); X is O, S, Se, NR¹³, CR¹³R¹⁴ or SiR¹³R¹⁴; R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that at least one of C, D, R¹ to R¹⁰, R¹³ and R¹⁴ contains a phosphoramidite moiety as shown below:

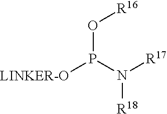

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG); R¹⁶ to R¹⁸ are independently an alkyl, a halogenated alkyl, a cyanoalkyl, a cycloalkyl, an arylalkyl, an alkoxyalkyl or a polyethyleneglycol (PEG).

Another preferred embodiment is a compound of Formula IV:

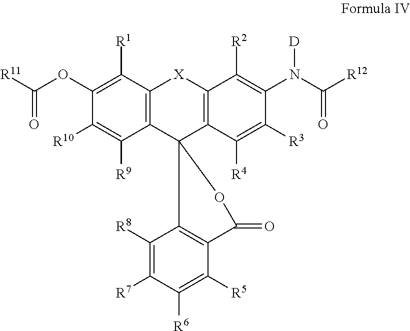

wherein D is a hydrogen, an alkyl, a halogenated alkyl, a cycloalkyl, an aryl, an arylalkyl, an alkoxyalkyl or a polyethyleneglycol (PEG); X is O, S, Se, NR¹³, CR¹³R¹⁴ or SiR¹³R¹⁴; R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of D and R² or D and R³ are optionally taken in combination to form a cycloalkyl, a hetero ring, an aryl or a heteroaryl ring; R¹¹ and R¹² are independently an alkyl, a halogenated an alkyl, a perfluoroalkyl, a cycloalkyl, an arylalkyl, an alkoxyalkyl, a polyethyleneglycol (PEG), an aryl or a heteroaryl; provided that at least one of D, R¹ to R¹⁰, R¹³ and R¹⁴ contains a phosphoramidite moiety as shown below:

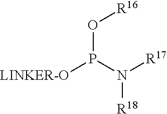

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG); R¹⁶ to R¹⁸ are independently an alkyl, a halogenated alkyl, a cyanoalkyl, a cycloalkyl, an arylalkyl, an alkoxyalkyl or a polyethyleneglycol (PEG).

Another preferred embodiment is a compound of Formula V:

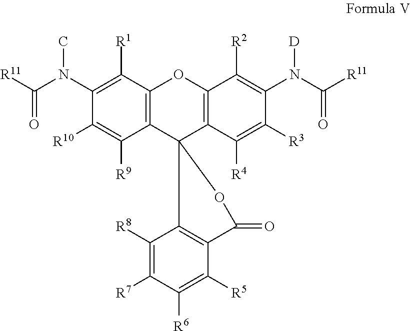

wherein C and D are independently a hydrogen, an alkyl, a halogenated alkyl, a cycloalkyl, an aryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that at least one of C, D and R¹ to R¹⁰ contains a phosphoramidite moiety as shown below:

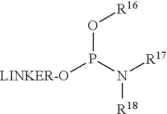

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG); R¹⁶ to R¹⁸ are independently an alkyl, a halogenated alkyl, a cyanoalkyl, a cycloalkyl, an arylalkyl, an alkoxyalkyl or a polyethyleneglycol (PEG).

Another preferred embodiment is a compound of Formula VI:

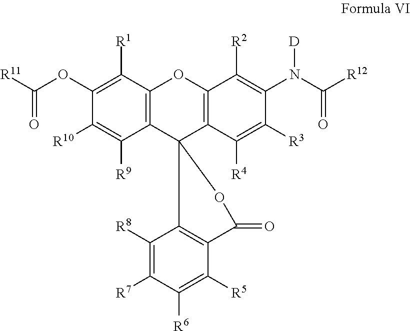

wherein D is a hydrogen, an alkyl, a cycloalkyl, an arylalkyl, a halogenated alkyl, an alkoxyalkyl, an aryl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of D and R² or D and R³ are optionally taken in combination to form a cycloalkyl, a hetero ring, an aryl or a heteroaryl ring; R¹¹ and R¹² are independently an alkyl, a halogenated an alkyl, a perfluoroalkyl, a cycloalkyl, an arylalkyl, an alkoxyalkyl, a polyethyleneglycol (PEG), an aryl or a heteroaryl; provided that at least one of D and R¹ to R¹⁰ contains a phosphoramidite moiety as shown below:

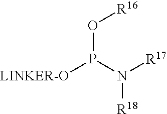

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG); R¹⁶ to R¹⁸ are independently an alkyl, a halogenated alkyl, a cyanoalkyl, a cycloalkyl, an arylalkyl, an alkoxyalkyl or a polyethyleneglycol (PEG).

Another preferred embodiment is a compound of Formula VII:

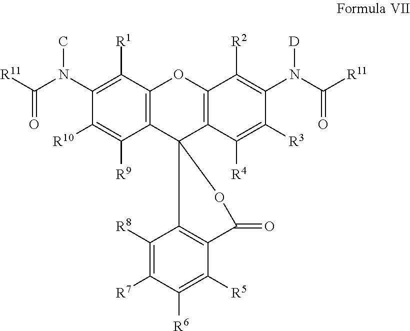

wherein C and D are independently a hydrogen, an alkyl, a halogenated alkyl, a cycloalkyl, an aryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that R⁶ or R⁷ contains a phosphoramidite moiety as shown below:

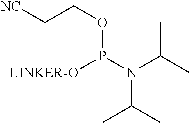

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula VIII:

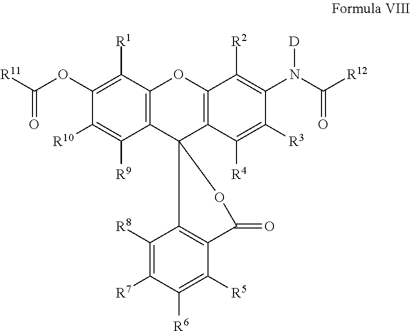

wherein D is a hydrogen, an alkyl, a cycloalkyl, an aryl, an arylalkyl, a halogenated alkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of D and R² or D and R³ are optionally taken in combination to form a cycloalkyl, a hetero ring, an aryl or a heteroaryl ring; R¹¹ and R¹² are independently an alkyl, a halogenated alkyl, a perfluoroalkyl, a cycloalkyl, an arylalkyl, an alkoxyalkyl, a polyethyleneglycol (PEG), an aryl or a heteroaryl; provided that R⁶ or R⁷ contains a phosphoramidite moiety as shown below:

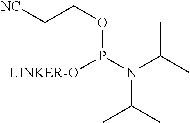

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula IX:

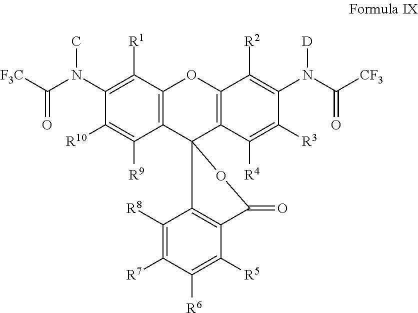

wherein C and D are independently a hydrogen, an alkyl, a halogenated alkyl, a cycloalkyl, an aryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; provided that R⁶ or R⁷ contains a phosphoramidite moiety as shown below:

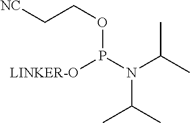

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula X:

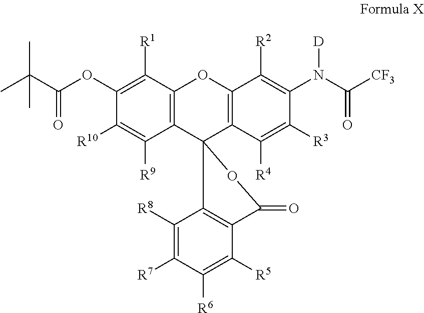

wherein D is a hydrogen, an alkyl, a cycloalkyl, an aryl, an arylalkyl, a halogenated alkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of D and R² or D and R³ are optionally taken in combination to form a cycloalkyl, a hetero ring, an aryl or a heteroaryl ring; provided that R⁶ or R⁷ contains a phosphoramidite moiety as shown below:

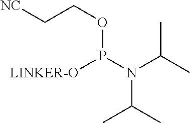

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula XI:

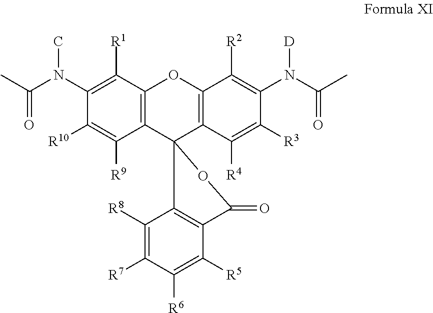

wherein C and D are independently a hydrogen, an alkyl, a halogenated alkyl, a cycloalkyl, an aryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; provided that R⁶ or R⁷ contains a phosphoramidite moiety as shown below:

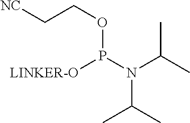

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula XII:

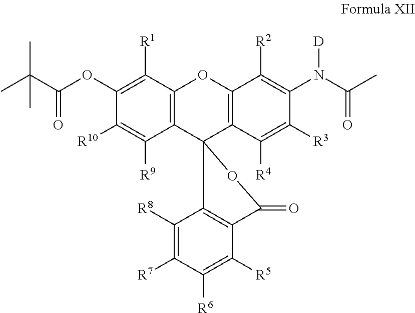

wherein D is a hydrogen, an alkyl, a halogenated alkyl, a cycloalkyl, an aryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of D and R² or D and R³ are optionally taken in combination to form a cycloalkyl, a hetero ring, an aryl or a heteroaryl ring; provided that R⁶ or R⁷ contains a phosphoramidite moiety as shown below:

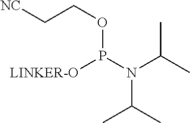

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula XIII:

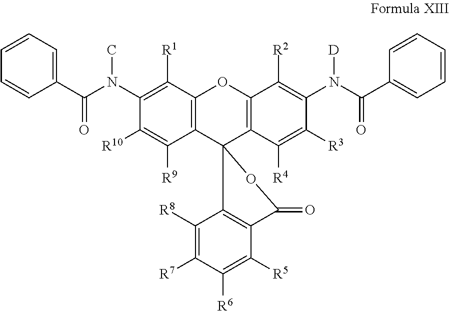

wherein C and D are independently a hydrogen, an alkyl, a halogenated alkyl, a cycloalkyl, an aryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; provided that R⁶ or R⁷ contains a phosphoramidite moiety as shown below:

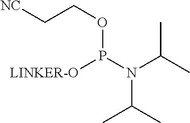

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula XIV:

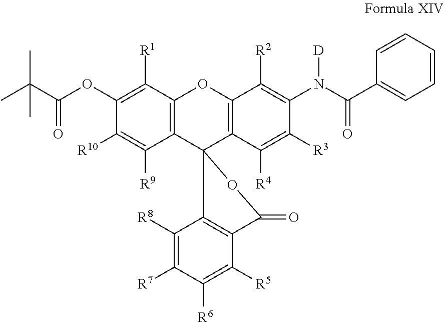

wherein D is a hydrogen, an alkyl, a halogenated alkyl, a cycloalkyl, an aryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of D and R² or D and R³ are optionally taken in combination to form a cycloalkyl, a hetero ring, an aryl or a heteroaryl ring; provided that R⁶ or R⁷ contains a phosphoramidite moiety as shown below:

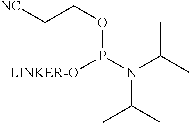

Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

Another preferred embodiment is a compound of Formula XV:

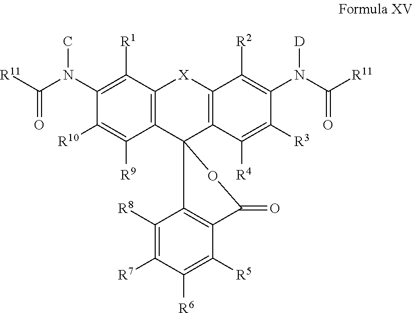

wherein C and D are independently a hydrogen, an alkyl, a halogenated alkyl, a cycloalkyl, an aryl, an arylalkyl, an alkoxyalkyl or a polyethyleneglycol (PEG); X is O, S, Se, NR¹³, CR¹³R¹⁴ or SiR¹³R¹⁴; R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that one of C, D, R¹ to R¹⁰, R¹³ and R¹⁴ is bonded to polymer support through an ester linkage.

Another preferred embodiment is a compound of Formula XVI:

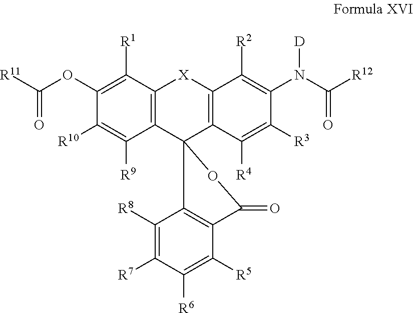

wherein D is a hydrogen, an alkyl, a halogenated alkyl, a cycloalkyl, an aryl, an arylalkyl, an alkoxyalkyl or a polyethyleneglycol (PEG); X is O, S, Se, CR¹³R¹⁴ or SiR¹³R¹⁴; R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of D and R² or D and R³ are optionally taken in combination to form a cycloalkyl, a hetero ring, an aryl or a heteroaryl ring; R¹¹ and R¹² are independently an alkyl, a halogenated alkyl, a perfluoroalkyl, a cycloalkyl, an arylalkyl, an alkoxyalkyl, a polyethyleneglycol (PEG), an aryl or a heteroaryl; provided that one of D, R¹ to R¹⁰, R¹³ and R¹⁴ is bonded to polymer support through an ester linkage.

It is to be understood that the dyes of the invention have been drawn in one or another particular electronic resonance structure. Every aspect of the instant invention applies equally to dyes that are formally drawn with other permitted resonance structures, as the electronic charge on the subject dyes is delocalized throughout the dye itself.

Other conjugates of non-biological materials include dye-conjugates of organic or inorganic polymers, polymeric films, polymeric wafers, polymeric membranes, polymeric particles, or polymeric microparticles (magnetic and non-magnetic microspheres); iron, gold or silver particles; conducting and non-conducting metals and non-metals; and glass and plastic surfaces and particles. Conjugates are optionally prepared by copolymerization of a dye that contains an appropriate functionality while preparing the polymer, or by chemical modification of a polymer that contains functional groups with suitable chemical reactivity. Other types of reactions that are useful for preparing dye-conjugates of polymers include catalyzed polymerizations or copolymerizations of alkenes and reactions of dienes with dienophiles, transesterifications or transaminations. In another embodiment, the conjugated substance is a glass or silica, which may be formed into an optical fiber or other structure.

In one embodiment, conjugates of biological polymers such as peptides, proteins, oligonucleotides, nucleic acid polymers are also labeled with at least a second luminescent dye, which is optionally an additional dye of the present invention, to form an energy-transfer pair. In some aspects of the invention, the labeled conjugate functions as an enzyme substrate, and enzymatic hydrolysis disrupts the energy transfer. In another embodiment of the invention, the energy-transfer pair that incorporates a dye of the invention is conjugated to an oligonucleotide that displays efficient fluorescence quenching in its hairpin conformation, e.g., U.S. Pat. No. 7,671,184 to Haener, et al. (2010); U.S. Pat. No. 7,553,955 to El-Deiry et al. (2009); U.S. Pat. No. 7,399,591 to Bao, et al. (2008). Selected embodiments of the invention are given in Table 1.

TABLE 1
Selected embodiment of the compounds of the invention:

| Code | Chemical Structure |
|---|---|
| 4 | 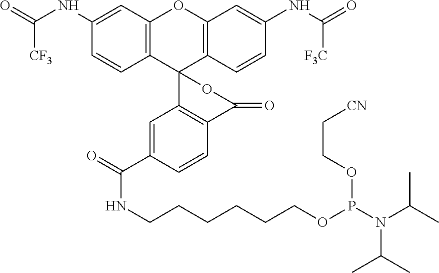 |
| 8 | 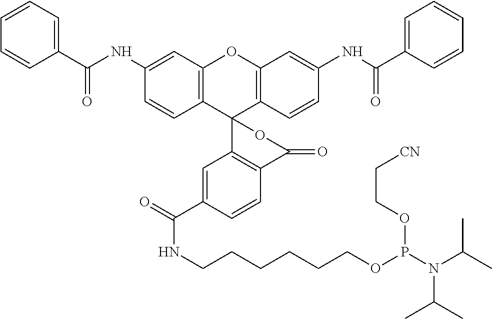 |
| 12 | 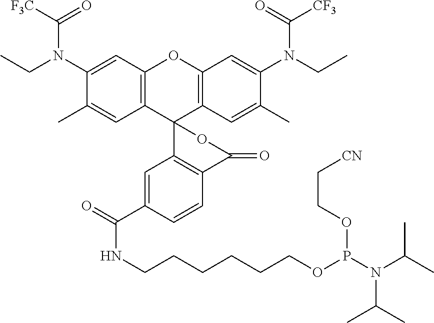 |
| 14 | 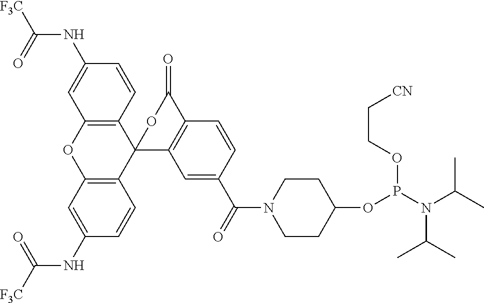 |
| 16 | 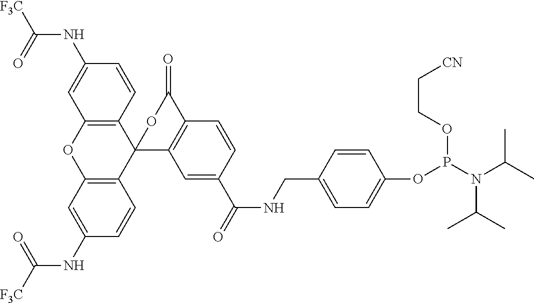 |
| 17 | 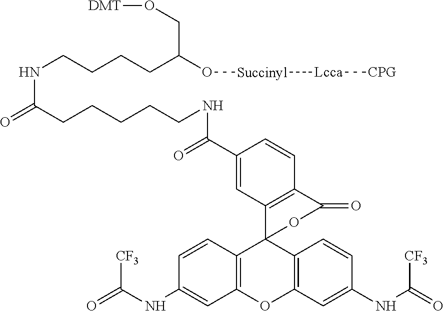 |
| 24 | 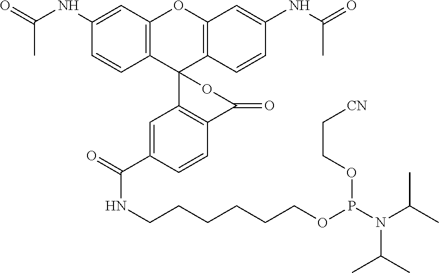 |
| 25 | 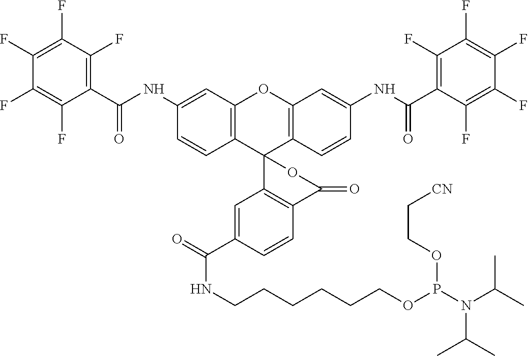 |
| 26 | 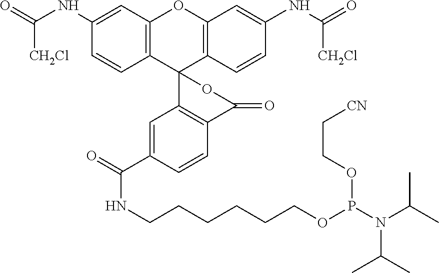 |
| 27 | 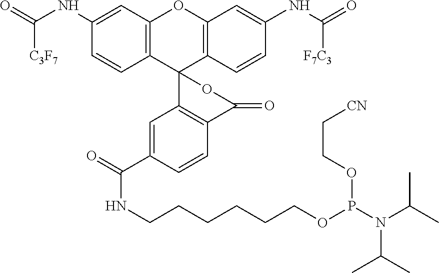 |
| 28 | 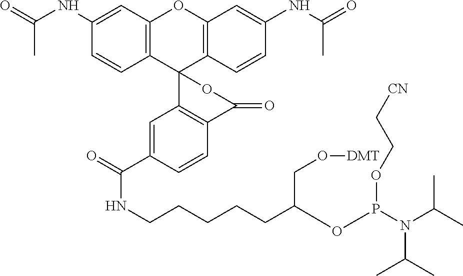 |
| 29 | 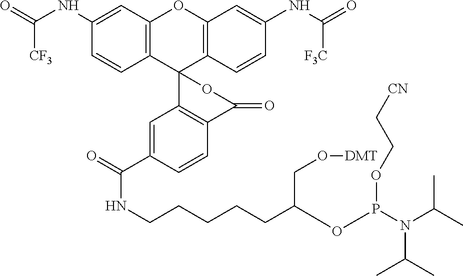 |
| 30 | 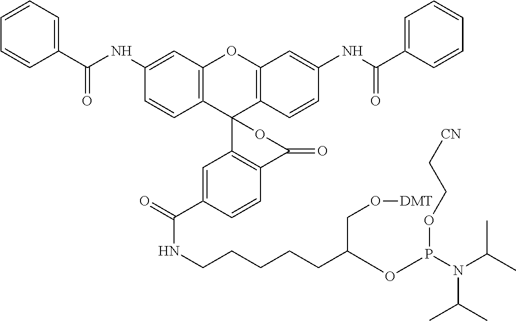 |
| 50 | 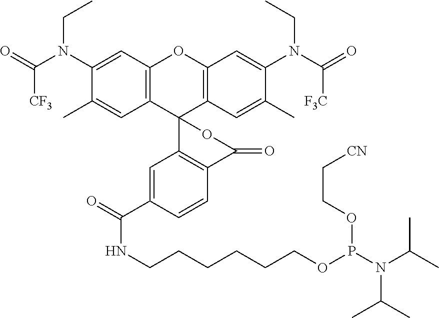 |
| 51 | 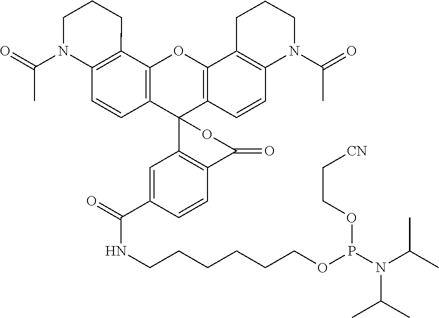 |
| 52 | 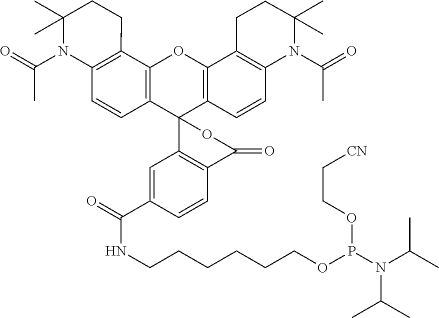 |
| 53 | 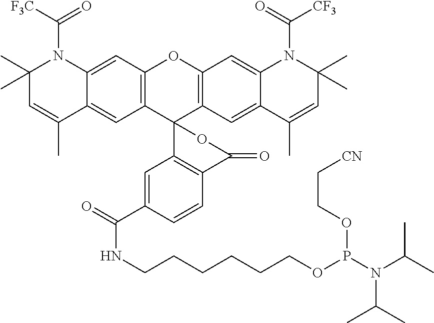 |
| 54 | 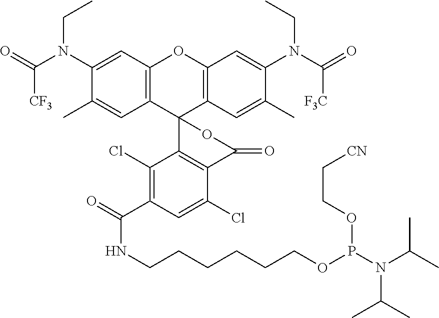 |
| 55 | 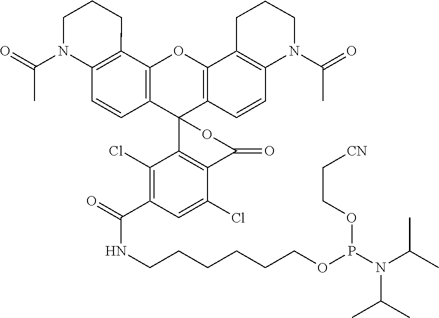 |
| 56 | 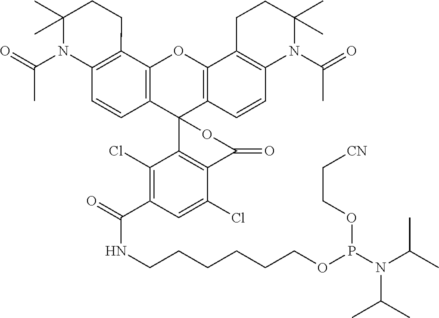 |
| 57 | 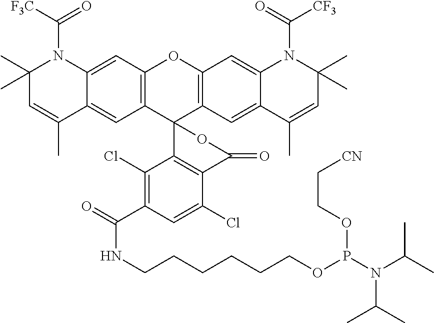 |
| 58 | 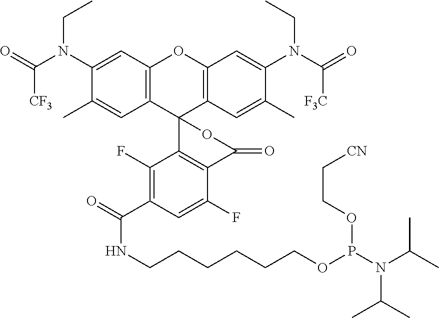 |
| 59 | 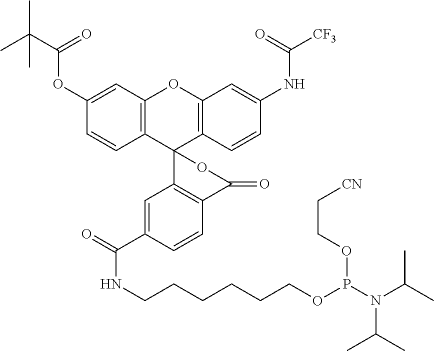 |
| 60 | 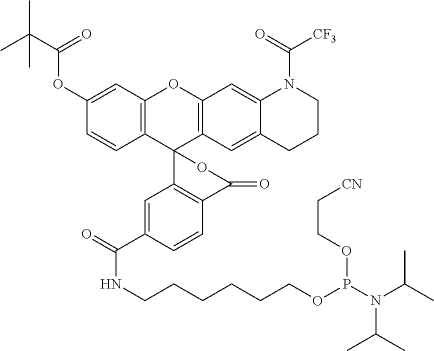 |
| 61 | 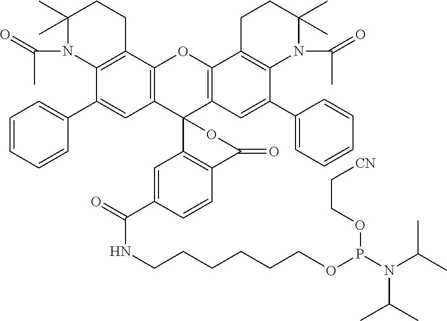 |
| 62 | 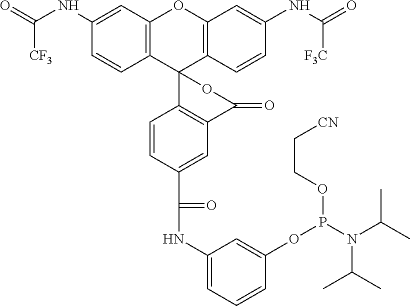 |
| 63 | 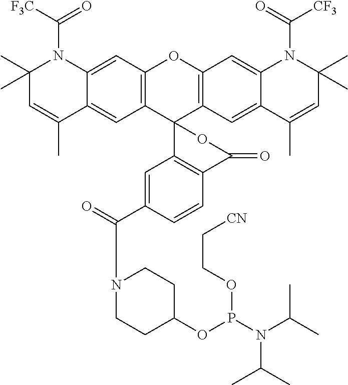 |
| 64 | 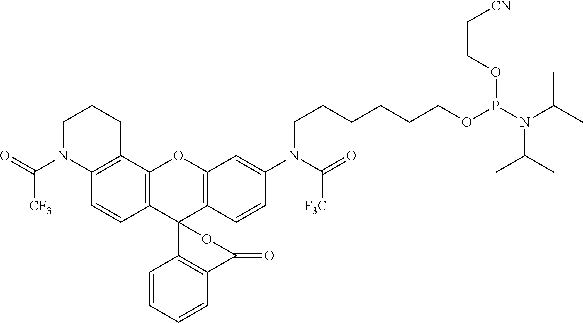 |
| 65 | 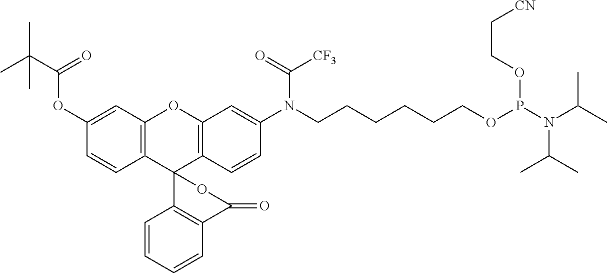 |
| 66 | 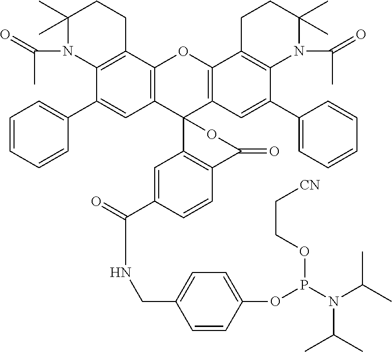 |
| 67 | 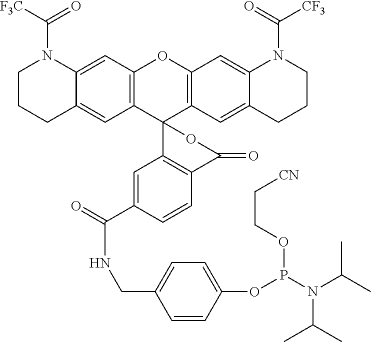 |
| 68 | 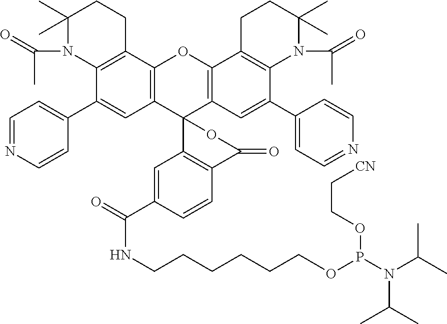 |
| 69 | 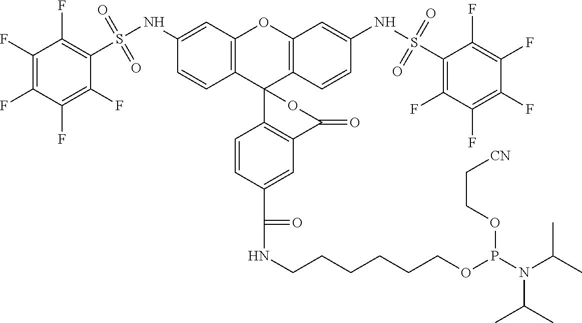 |
| 70 | 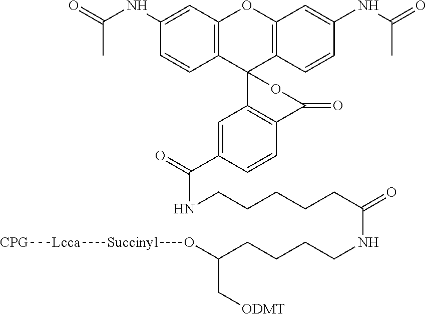 |
| 71 | 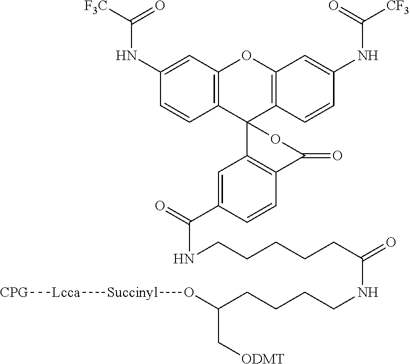 |
| 72 | 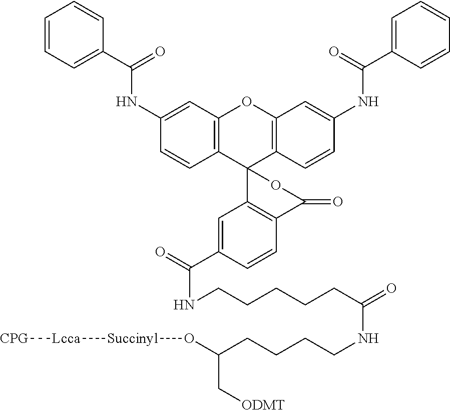 |
| 73 | 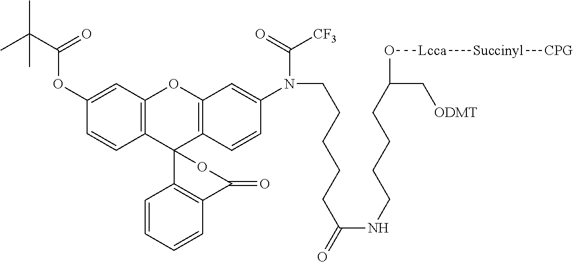 |
| 74 | 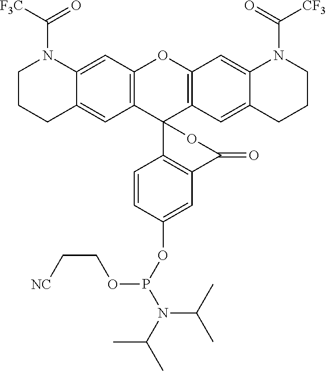 |
| 75 | 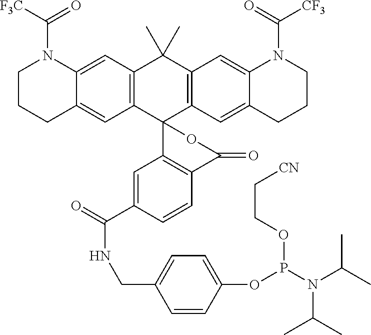 |
| 76 | 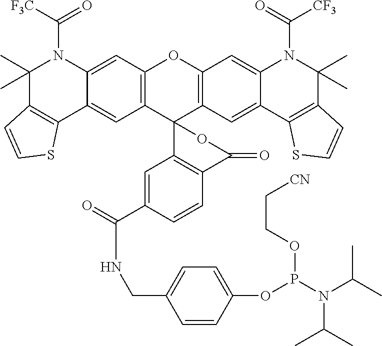 |
| 77 | 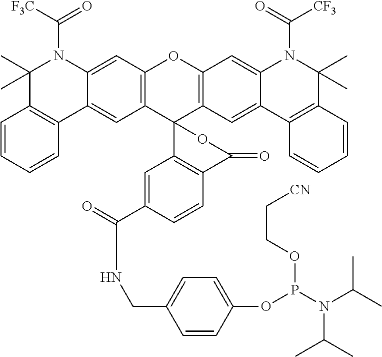 |
| 78 | 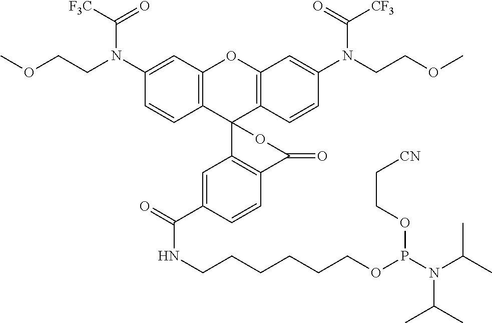 |
| 80 | 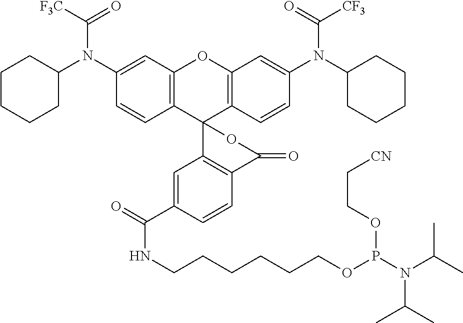 |
| 81 | 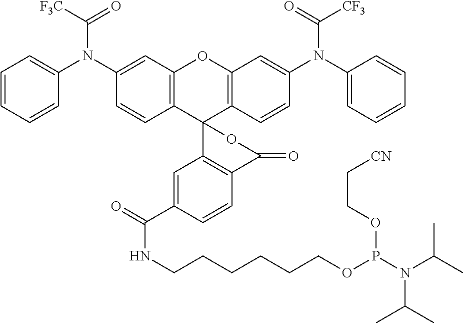 |
| 82 | 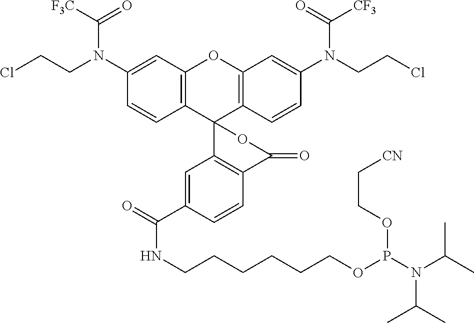 |
| 83 | 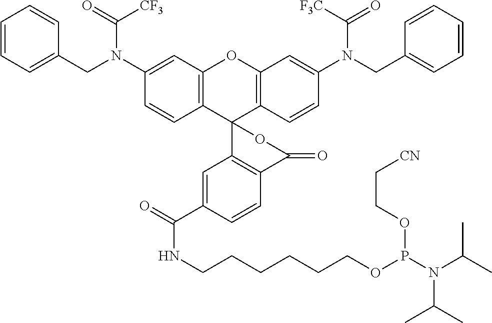 |
| 84 | 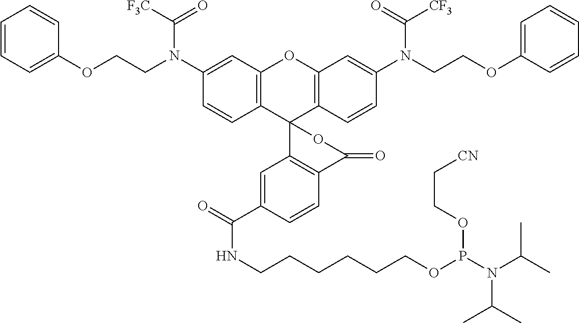 |
| 85 | 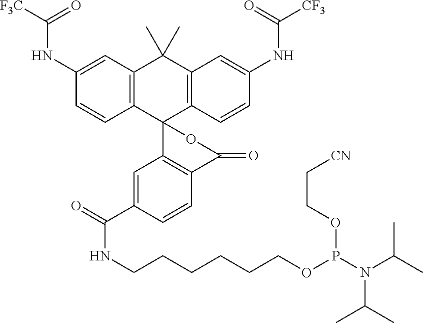 |
| 86 | 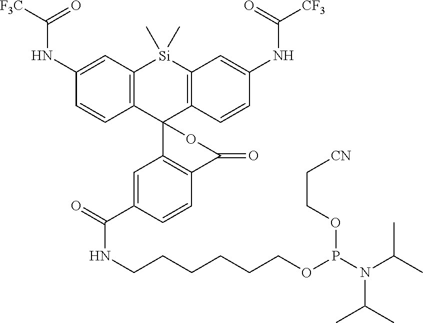 |
| 87 | 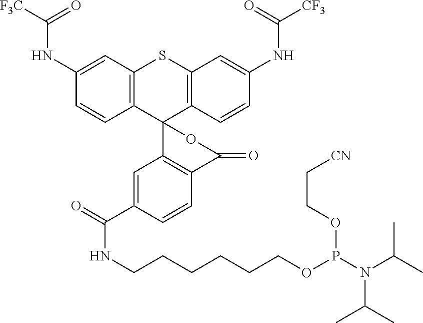 |
| 88 | 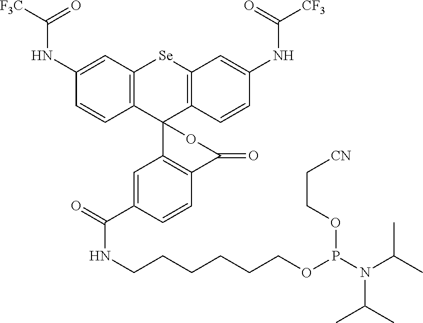 |
| 89 | 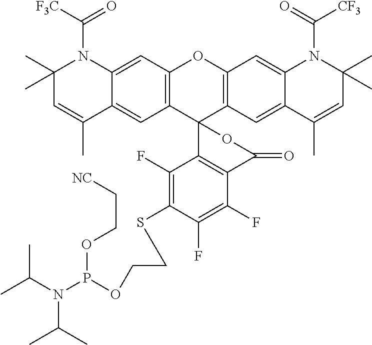 |
| 90 | 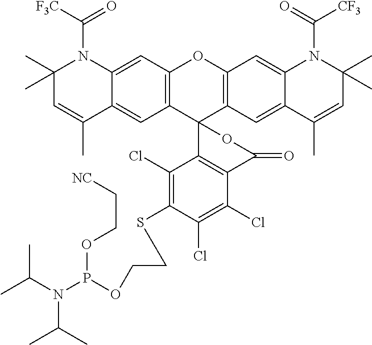 |
| 91 | 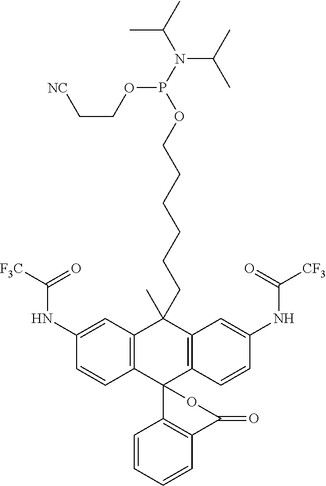 |
| 92 | 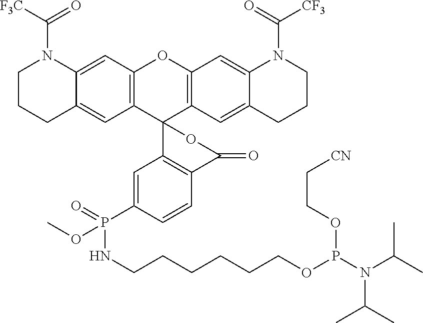 |
| 93 | 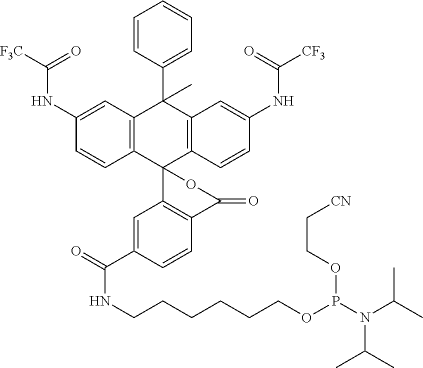 |
| 94 | 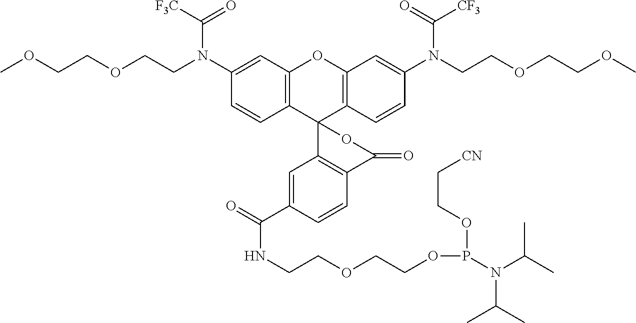 |
| 95 | 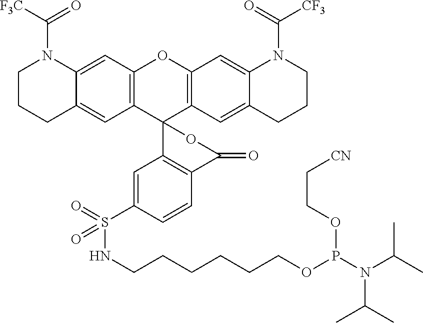 |
| 96 | 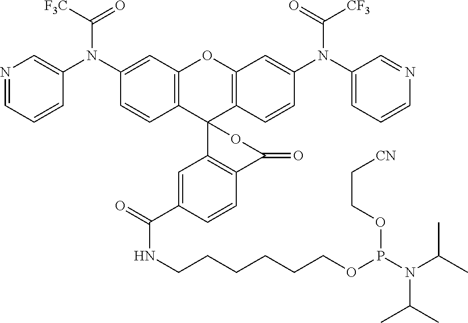 |

Detailed descriptions of the procedures for solid phase synthesis of oligonucleotides by phosphoramidite chemistries are widely available, e.g. Reddy, et al., U.S. Pat. No. 7,339,052 (2008); Pitner, et al., U.S. Pat. No. 6,114,518 (2000); Matteucci, et al, J. Am. Chem. Soc. 103, 3185-3191 (1981); Gait, “OLIGONUCLEOTIDE SYNTHESIS: A PRACTICAL APPROACH”, IRL Press, Washington, D.C., 1984; Froehler, et al, Tetrahedron Letters, Vol. 27, Pgs. 469-472 (1986); Garegg, et al, Tetrahedron Letters, Vol. 27, 4051-4054 and 4055-4058 (1986). Preferably, the present invention involves synthesis of rhodamine-labeled oligonucleotides by the phosphoramidite approach. That is, nucleotides are successively added to a growing chain of nucleotides by reacting nucleoside phosphoramidites with the 5′-hydroxy group of the growing chain. In particular, oligonucleotides are labeled by reacting a rhodamine lactone phosphoramidite with the 5′-hydroxy group of the attached oligonucleotide.

Rhodamine lactone phosphoramidites of the invention are made by first reacting the N-hydroxysuccinimide (NHS) esters of 5- or 6-carboxyrhodamine lactone with an amino alcohol, e.g. ethanol amine, 6-hydroxyhexamine, or the like, in N,N-dimethylformamide (DMF), or like aprotic polar solvent, at room temperature to form a 5- or 6-alcohol amide of the rhodamine lactone dye, which is then separated from the reaction mixture by the standard purification means such as silica gel column chromatography. The alcohol amide of the rhodamine lactone is then reacted with an excess of di-(N,N-diisopropylamino)alkoxyphosphine at room temperature in acetonitrile, dichloromethane or other organic solvents containing catalytic amounts of tetrazole (or similar catalyst) and diisopropylamine (or other bases) or pyridine TFA salt, to form the rhodamine phosphoramidite, which is separated from the reaction mixture by the standard purification means such as silica gel column chromatography.

Generally, cleavage and deprotection are effected by the cleavage reagent of the invention by first exposing an oligonucleotide attached to a solid phase support (via a base-labile bond) to the cleavage reagent at room temperature for about 1-2 hours so that the oligonucleotide is released from the solid support, and then heating the cleavage reagent containing the released oligonucleotide for about 20 to about 60 minutes at about 60-90° C. so that the protection groups attached to the exocyclic amines are removed. Alternatively, the deprotection step can take place at a lower temperature, but the reaction will take longer to complete, e.g. the heating can be at 50° C. for 5 hours etc. After cleavage and deprotection, the labeled or unlabeled oligonucleotides are purified by standard procedures, e.g., Gait, “Oligonucleotide Synthesis: A Practical Approach” IRL Press, Washington, D.C., 1984; or oligo synthesizers's manuals.

### Synthesis

Rhodamine dyes are generally prepared from the condensation of 3-aminophenols with phthalic anhydrides or the condensation of 3-aminophenols with aldehydes followed by oxidation. The condensation of 1:1 mixed 3-aminophenols/resorcinols with phthalic anhydrides or the condensation of 1:1 mixed 3-aminophenols/resorcinols with aldehydes followed by oxidation generates rhodols. Alternatively rhodols are prepared from the condensation of 3-aminophenols with 4-carbonylresorcinols or the condensation of resorcinols with 4-carbonyl-3-aminophenols. These methods are well described in the literature, e.g., U.S. Pat. No. 7,704,284 to Eliu, et al. (2010); U.S. Pat. No. 7,491,830 to Lam, et al. (2009); U.S. Pat. No. 7,344,701 to Reddington, et al. (2008); U.S. Pat. No. 6,828,159 to Drexhage, et al. (2001); U.S. Pat. No. 6,229,055 to Klaubert, et al. (2001); U.S. Pat. No. 6,130,101 to Mao et al. (2000); Venkataraman, “THE CHEMISTRY OF SYNTHETIC DYES”, Volume 2, 1952. It is recognized that there are many possible variations that may yield equivalent results.

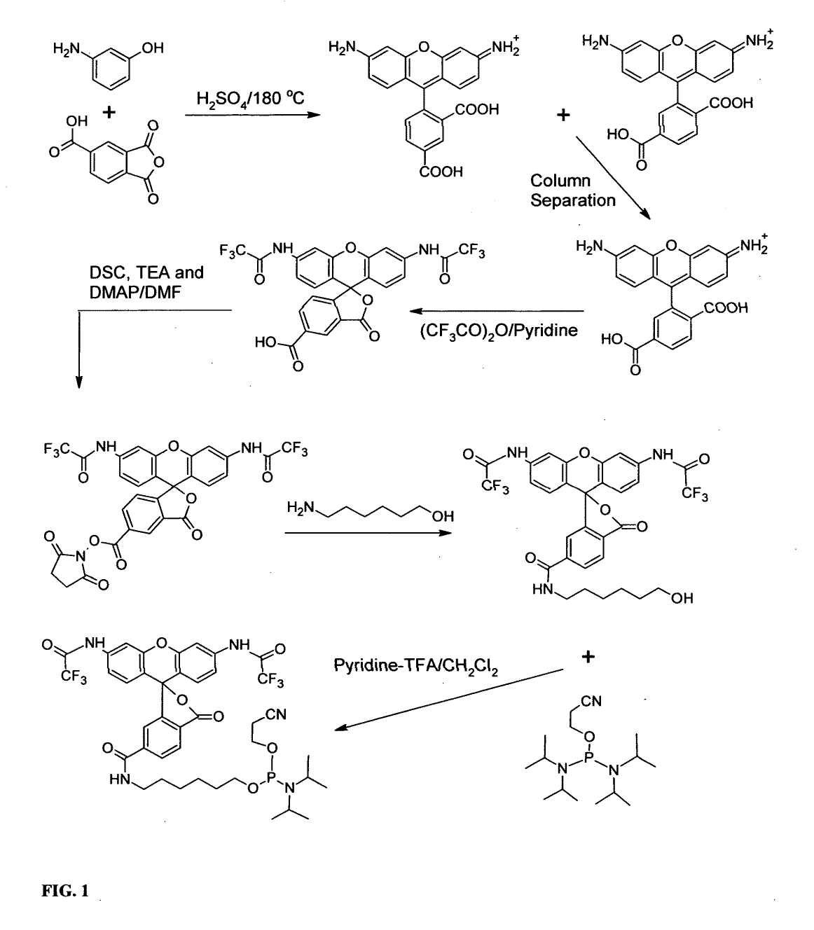

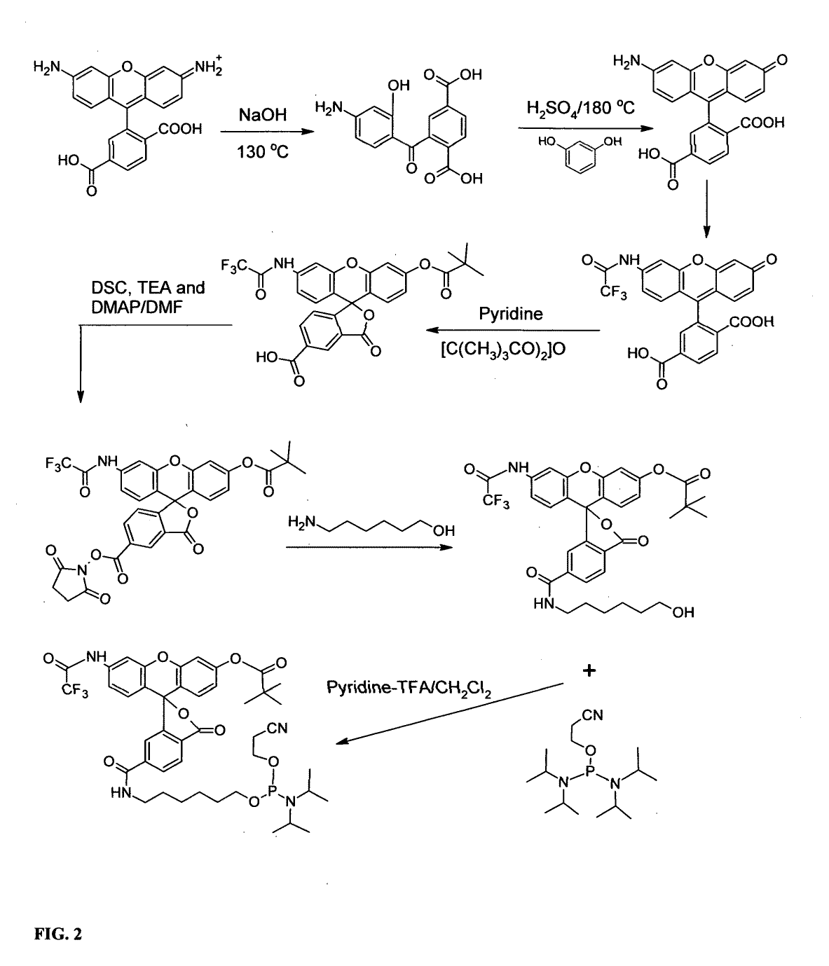

As described above the synthesis of the rhodamine and rhodol dyes of the invention depends on initial preparation of appropriately substituted 3-aminophenol and resorcinol intermediates. For the synthesis of a desired rhodamine, an appropriately substituted 3-aminophenol is reacted with an appropriately substituted phthalic anhydride to yield a carboxy rhodamine derivative. The quinoid rhodamine is reacted with an active carbonyl or sulfonyl compound to give the protected rhodamine lactone compound. This synthetic method is illustrated in FIG. 1. For the synthesis of a desired rhodol, an appropriately substituted 3-aminophenol is reacted with an appropriately substituted 4-carbonyl-3-aminophenol to yield the desired carboxy rhodol derivative. The quinoid rhodol is reacted with an active carbonyl or sulfonyl compound to give the protected rhodol lactone compound. This synthetic method is illustrated in FIG. 2.

In order to facilitate the introduction of rhodamine or rhodol lactone dye labels to oligonucleotides, rhodamine or rhodol lactone phosphoramidites are synthesized as shown in the examples. The rhodamine- or rhodol-linked phosphoramidites can be used directly on any oligo synthesizer to automatically add the dyes to any nucleotide position, including the preferred 5′-end of the oligomer. The time for the coupling step and the concentration of reagent needed is similar as for the usual nucleoside phosphoramidites. By the use of nucleoside protecting groups that are rapidly removed, the total time for the preparation of a labeled oligonucleotide is significantly reduced with rhodamine- or rhodol-linked phosphoramidites compared to the indirect labeling method with rhodamine or rhodol succinimidyl esters. The yield of labeled product is also greater and the purification simpler with the phosphoramidite labeling method compared to the indirect labeling method with rhodamine or rhodol succinimidyl esters.

Where the intended biomolecule of the conjugate is a nucleotide, oligonucleotide, or nucleic acid, then the chemically reactive functional group is preferably a phosphoramidite. When reacted with a hydroxyl functional group, the phosphoramidite forms a phosphite ester which, in turn, may be oxidized to give a phosphate ester. By phosphoramidite is meant a moiety having Formula XVII:

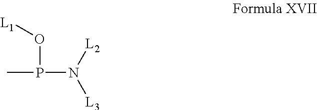

In Formula XVII, L₁ is cyanoethyl, alkyl, alkenyl, aryl, arylalkyl, or cycloalkyl; L₂ and L₃ taken separately each represent alkyl, arylalkyl, cycloalkyl, and cycloalkylaryl; L₁ and L₂ taken together form an alkylene chain containing up to 5 carbon atoms in the principal chain and a total of up to 10 carbon atoms with both terminal valence bonds of said chain being attached to the nitrogen atom to which L₂ and L₃ are attached; or L₂ and L₃ taken together with the nitrogen atom to which they are attached form a saturated nitrogen heterocycle which contains one or more heteroatoms from the group consisting of nitrogen, oxygen, or sulfur.

Thus, oligonucleotides may be labeled by reacting rhodamine or rhodol fluorophores having phosphoramidite groups with the 5′-hydroxy group of an oligonucleotide. Since rhodamine or rhodols are generally unstable to basic conditions, mild conditions for the rapid removal of protecting groups are desired to deprotect an oligonucleotide bearing a rhodamine or rhodol moiety. Some nucleoside protecting groups can be removed under relatively mild conditions, especially the commercially available phenoxyacetyl protection, making possible the improved method of attaching rhodamine or rhodols to oligonucleotides. The inclusion of an acid labile trityl group in the molecule allows the dye to be inserted anywhere in the oligonucleotide, or to have additional modifying groups present, such as a hydrophilic phosphate or a second dye moiety. Methods to produce these rhodamine or rhodol compounds are generally known to those of skill in the art. Suitable specific procedures are described below in the Examples.

Use of the various trityl groups, all of which are removable under acidic conditions, adds versatility to the invention. The monomethoxytrityl (MMT) is preferred for its balance of stability during synthesis and ease of removal when desired. However, other protecting groups, such as dimethoxytrityl (DMT) or acyl groups, are suitable for the present invention.

The dimethoxytrityl group is routinely removed by mild acid treatment in the cycle for synthesis of oligonucleotides with nucleoside phosphoramidites. Some DMT-containing rhodamine or rhodol phosphoramidites of the invention can be treated as a nucleotide, in that it can be added anywhere in the sequence, including the 3′-end. The preferred point of addition is the 5′-end of the oligonucleotide, where interference with hybridization by the dye label is minimized. Removal of the trityl group leaves a hydroxy group, which is the commonly used form. If it is desired to make the dye portion of the molecule more hydrophilic, a commercially available phosphorylating phosphoramidite can be used to introduce a phosphate group after detritylation of the rhodamine or rhodols compounds that contain a trityl group. At this point, a variety of aryl group-containing moieties may be added to the dye. By “aryl-group containing moieties” we mean groups that are capable of being added to the compound of the present invention at the desired position after oligonucleotide coupling and should not interfere with the oligonucleotide. An example is the addition of a second rhodamine or rhodol dye as a FRET pair.

Addition of a second rhodamine or rhodol is possible by a second coupling of the dye phosphoramidite. Also, other dyes which are available as phosphoramidites may be added in the same way to give a multi-color labeled oligonucleotide. Specific examples of suitable dyes are fluoresceins, rhodamines, and cyanines. Such multi-colored labeled oligonucleotides may be useful in multiple excitation and/or multiple detection mode instruments, or in detection by FRET.

One significance of this invention lies in the fact that rhodamine or rhodols, a useful label for fluorescent detection in biomolecules and of significance in DNA sequencing, can now be added to an oligonucleotide in a single automated step on any DNA synthesizer. The overall preparation and purification time to prepare dye-linked oligonucleotides is significantly reduced. Use of the rhodamine or rhodol lactone phosphoramidites obviates the reaction of oligonucleotide and label after completion of the synthesis and deprotection. Furthermore it is not necessary to separate the product from a large excess of labeling reagent. Due to the liability of the rhodamine moiety in concentrated ammonia at 55° C. for 5-16 hours, the use of phenoxyacetyl protection for the heterocyclic bases is recommended.

### Applications and Methods of Use

The fluorescent rhodamine or rhodol labels may be used in conjunction with quenching dyes in FRET reactions. FRET occurs between a donor fluorophore and a quenching acceptor dye when the absorption spectrum of the acceptor dye overlaps the emission spectrum of the donor fluorophore, and the two dyes are in close proximity. Upon excitation of the donor molecule, for example with ultraviolet energy, the energy emitted from the donor molecule is transferred to the neighboring acceptor molecule which accepts and quenches this energy. This acceptance of the energy by the acceptor results in quenching of donor fluorescence. The overall effect of such energy transfer is that the emission of the donor is not detected until the donor and acceptor are separated, for example upon hybridization of a labeled probe to a target nucleotide.

In practice, the donor and acceptor molecules may either reside on complementary oligonucleotides or on a single oligonucleotide. When incorporated into complementary oligonucleotides, quenching occurs upon hybridization of the separately labeled oligonucleotides. In contrast, when the donor and acceptor are linked to a single oligonucleotide, hybridization to the target oligonucleotide usually results in reduced quenching due to an increased distance between the donor and acceptor which decreases the effect of energy transfer. Reduced quenching is observed as increased ability to detect the energy emitted from the donor. For example, an acceptor and a donor may be linked to the ends of a self-complementary oligonucleotide such that under non-hybridizing conditions a hairpin is formed which brings the acceptor and donor into close proximity and causes quenching. Hybridization of the self-complementary oligonucleotide results in linearization of the hairpin and reduced quenching. Additionally, to further contribute to the change in fluorescence upon hybridization, a restriction endonuclease site may be placed between the acceptor and donor dyes such that the site is only cleavable in the presence of target binding.

The rhodamine or rhodol dyes of this invention might be used with quenching dyes such as DABSYL, Black Hole Quenchers, QSY dyes and Tide Quencher compounds. These quenching molecules have absorption spectra that overlap the emission spectrum of the rhodamine or rhodol dyes of this invention. These quenchers are non-fluorescent chromophores, and therefore provide an advantage of reduced assay background since they do not fluoresce when exposed to emission from the donor molecule or to the excitation wavelengths used to excite the donor.

In one aspect of the invention, the dye compounds of the invention are used to directly stain or label a sample so that the sample can be identified or quantitated. For instance, such dyes may be added as part of an assay for a biological target analyte, as a detectable tracer element in a biological or non-biological fluid; or for such purposes as photodynamic therapy of tumors, in which a dyed sample is irradiated to selectively destroy tumor cells and tissues; or to photoablate arterial plaque or cells, usually through the photosensitized production of singlet oxygen. In one preferred embodiment, dye conjugate is used to stain a sample that comprises a ligand for which the conjugated substance is a complementary member of a specific binding pair (e.g. Table 2).

TABLE 2
Representative specific binding pairs

| Antigen | Antibody |
|---|---|
| Biotin | Anti-biotin or avidin or |
| | streptavidin or neutravidin |
| IgG* | Protein A or protein G or |
| | anti-IgG antibody |
| Drug | Drug receptor |
| Toxin | Toxin receptor |
| Carbohydrate | Lectin or carbohydrate receptor |
| Peptide | Peptide receptor |
| Nucleotide | Complimentary nucleotide |
| Protein | Protein receptor |
| Enzyme substrate | Enzyme |
| DNA (RNA) | aDNA (aRNA)** |
| Hormone | Hormone receptor |
| Psoralen | Nucleic acid |
| Target molecule | RNA or DNA aptamer |
| Ion | Ion chelator |

*IgG is an immunoglobulin;
**aDNA and aRNA are the antisense (complementary) strands used for hybridization

Typically, the sample is obtained directly from a liquid source or as a wash from a solid material (organic or inorganic) or a growth medium in which cells have been introduced for culturing, or a buffer solution in which cells have been placed for evaluation. Where the sample comprises cells, the cells are optionally single cells, including microorganisms, or multiple cells associated with other cells in two or three dimensional layers, including multicellular organisms, embryos, tissues, biopsies, filaments, biofilms, etc.

Alternatively, the sample is a solid, optionally a smear or a scrape or a retentate removed from a liquid or vapor by filtration. In one aspect of the invention, the sample is obtained from a biological fluid, including separated or unfiltered biological fluids such as urine, cerebrospinal fluid, blood, lymph fluids, tissue homogenate, interstitial fluid, cell extracts, mucus, saliva, sputum, stool, physiological secretions or other similar fluids. Alternatively, the sample is obtained from an environmental source such as soil, water, or air; or from an industrial source such as taken from a waste stream, a water source, a supply line, or a production lot.

In yet another embodiment, the sample is present on or in solid or semi-solid matrix. In one aspect of the invention, the matrix is a membrane. In another aspect, the matrix is an electrophoretic gel, such as is used for separating and characterizing nucleic acids or proteins, or is a blot prepared by transfer from an electrophoretic gel to a membrane. In another aspect, the matrix is a silicon chip or glass slide, and the analyte of interest has been immobilized on the chip or slide in an array (e.g. the sample comprises proteins or nucleic acid polymers in a microarray). In yet another aspect, the matrix is a microwell plate or microfluidic chip, and the sample is analyzed by automated methods, typically by various methods of high-throughput screening, such as drug screening.

The dye compounds of the invention are generally utilized by combining a dye compound of the invention as described above with the sample of interest under conditions selected to yield a detectable optical response. The term “dye compound” is used herein to refer to all aspects of the claimed dyes, including both reactive dyes and dye conjugates. The dye compound typically forms a covalent or non-covalent association or complex with an element of the sample, or is simply present within the bounds of the sample or portion of the sample. The sample is then illuminated at a wavelength selected to elicit the optical response. Typically, staining the sample is used to determine a specified characteristic of the sample by further comparing the optical response with a standard or expected response.

A detectable optical response means a change in, or occurrence of, an optical signal that is detectable either by observation or instrumentally. Typically the detectable response is a change in fluorescence, such as a change in the intensity, excitation or emission wavelength distribution of fluorescence, fluorescence lifetime, fluorescence polarization, or a combination thereof. The degree and/or location of staining, compared with a standard or expected response, indicates whether and to what degree the sample possesses a given characteristic. Some dyes of the invention may exhibit little fluorescence emission, but are still useful as chromophoric dyes. Such chromophores are useful as energy acceptors in FRET applications, or to simply impart the desired color to a sample or portion of a sample.

For biological applications, the dye compounds of the invention are typically used in an aqueous, mostly aqueous or aqueous-miscible solution prepared according to methods generally known in the art. The exact concentration of dye compound is dependent upon the experimental conditions and the desired results, but typically ranges from about one nanomolar to one millimolar or higher. The optimal concentration is determined by systematic variation until satisfactory results with minimal background fluorescence are accomplished.

The dye compounds are most advantageously used to stain samples with biological components. The sample may comprise heterogeneous mixtures of components (including intact cells, cell extracts, bacteria, viruses, organelles, and mixtures thereof), or a single component or homogeneous group of components (e.g., natural or synthetic amino acids, nucleic acids or carbohydrate polymers, or lipid membrane complexes). These dyes are generally non-toxic to living cells and other biological components, within the concentrations of use.

Dye compounds that possess a lipophilic substituent, such as phospholipids, will non-covalently incorporate into lipid assemblies, e.g., for use as probes for membrane structure; or for incorporation in liposomes, lipoproteins, films, plastics, lipophilic microspheres or similar materials; or for tracing. Lipophilic dyes are useful as fluorescent probes of membrane structure.

Optionally, the sample is washed after staining to remove residual, excess or unbound dye compound. The sample is optionally combined with one or more other solutions in the course of staining, including wash solutions, permeabilization and/or fixation solutions, and solutions containing additional detection reagents. An additional detection reagent typically produces a detectable response due to the presence of a specific cell component, intracellular substance, or cellular condition, according to methods generally known in the art. Where the additional detection reagent has, or yields a product with, spectral properties that differ from those of the subject dye compounds, multi-color applications are possible. This is particularly useful where the additional detection reagent is a dye or dye-conjugate of the present invention having spectral properties that are detectably distinct from those of the staining dye.

The dye conjugates of the invention are used according to methods extensively known in the art; e.g. use of antibody conjugates in microscopy and immunofluorescent assays; and nucleotide or oligonucleotide conjugates for nucleic acid hybridization assays and nucleic acid sequencing (e.g., U.S. Pat. No. 5,332,666 to Prober, et al. (1994); U.S. Pat. No. 5,171,534 to Smith, et al. (1992); U.S. Pat. No. 4,997,928 to Hobbs (1991); and WO Appl. 94/05688 to Menchen, et al.). Dye-conjugates of multiple independent dyes of the invention possess utility for multi-color applications.

At any time after or during staining, the sample is illuminated with a wavelength of light selected to give a detectable optical response, and observed with a means for detecting the optical response. Equipment that is useful for illuminating the dye compounds of the invention includes, but is not limited to, hand-held ultraviolet lamps, mercury arc lamps, xenon lamps, lasers and laser diodes. These illumination sources are optionally integrated into laser scanners, fluorescence microplate readers, standard or minifluorometers, or chromatographic detectors. Preferred embodiments of the invention are dyes that are be excitable at or near the wavelengths 633-636 nm, 647 nm, 660 nm, 680 nm and beyond 700 nm, as these regions closely match the output of relatively inexpensive excitation sources.

The optical response is optionally detected by visual inspection, or by use of any of the following devices: CCD cameras, video cameras, photographic films, laser-scanning devices, fluorometers, photodiodes, quantum counters, epifluorescence microscopes, scanning microscopes, flow cytometers, fluorescence microplate readers, or by means for amplifying the signal such as photomultiplier tubes. Where the sample is examined using a flow cytometer, examination of the sample optionally includes sorting portions of the sample according to their fluorescence response.

One aspect of the instant invention is the formulation of kits that facilitate the practice of various assays using any of the dyes of the invention, as described above. The kits of the invention typically comprise a colored or fluorescent dye of the invention, either present as a chemically reactive label useful for preparing dye-conjugates, or present as a dye-conjugate where the conjugated substance is a specific binding pair member, or a nucleoside, a nucleotide, an oligonucleotide, a nucleic acid polymer, a peptide, or a protein. The kit optionally further comprises one or more buffering agents, typically present as an aqueous solution. The kits of the invention optionally further comprise additional detection reagents, a purification medium for purifying the resulting labeled substance, luminescence standards, enzymes, enzyme inhibitors, organic solvent, or instructions for carrying out an assay of the invention.

### EXAMPLES

Examples of some synthetic strategies for selected dyes of the invention, as well as their characterization, synthetic precursors, conjugates and method of use are provided in the examples below. Further modifications and permutations will be obvious to one skilled in the art. The examples below are given so as to illustrate the practice of this invention. They are not intended to limit or define the entire scope of this invention.

### Example 1

### Preparation of Compound 1

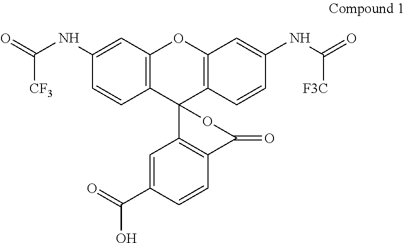

6-Carboxyrhodamine 110 (100 g) is dissolved in trifluoroacetic anhydride (500 mL). To the solution is added pyridine (250 mL) at 0° C. The solution is stirred at room temperature until 6-carboxyrhodamine 110 is completely consumed (The reaction is followed by TLC). This crude product is further purified by recrystallization in water.

### Example 2

### Preparation of Compound 2

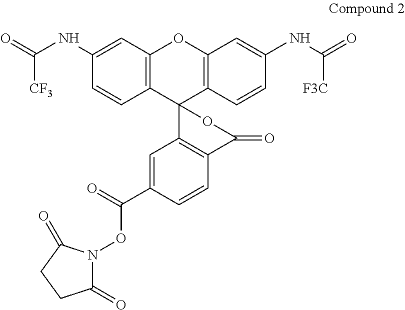

Compound 1 (20 g) is dissolved in DMF (50 mL). To the solution is added N,N′-disuccinimidyl carbonate (13 g). The solution is stirred while 4-dimethylaminopyridine (400 mg) is added. The reaction mixture is stirred at RT until >90% Compound 1 is consumed (˜8 hours). The reaction is followed by TLC every 4 h). This crude product is used for next step reaction without further purification.

### Example 3

### Preparation of Compound 3

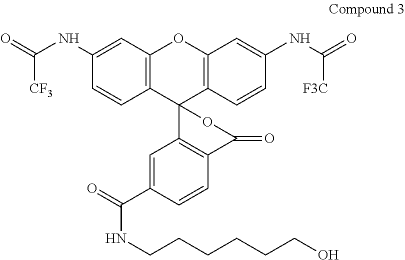

Compound 2 (10 g) is dissolved in acetonitrile (100 mL). To the solution is slowly added 6-aminohexanol (3 g) during the period of 6-8 hours. The mixture is stirred at room temperature overnight. After removal of solvent, the residue is purified on a silica gel column eluted with a gradient of chloroform/ethyl acetate.

### Example 4

### Preparation of Compound 4

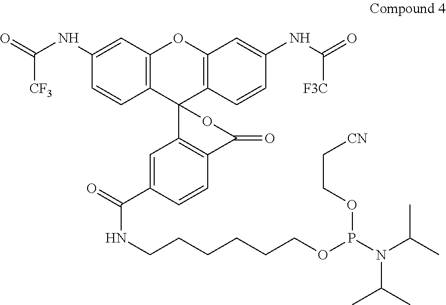

Thoroughly dried Compound 3 (5 g) is dissolved in 100 mL of dry dichloromethane. To the solution the phosphitylating agent, bis-(N,N-diisopropyl)-beta-cyanoethyl phosphordiamidite (2.7 g) is added, followed by pyridine TFA salt (1.7 g). The reaction is monitored by TLC until the starting material is consumed (˜4 hours). The solvent is evaporated and the flask evacuated under high vacuum for two hours. After removal of solvent, the residue is purified on a silica gel column eluted with a gradient of hexanes/ethyl acetate and 2% triethylamine. The solid is then dried under high vacuum overnight and stored under argon at −20° C.

### Example 5

### Preparation of Compound 5

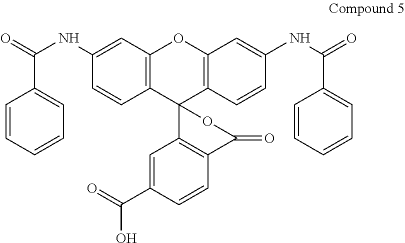

6-Carboxyrhodamine 110 (10 g) is dissolved in 1:1 pyridine/DMF (500 mL). To the solution is added benzoyl chloride (20 g) at 0° C. The solution is stirred at room temperature until 6-Carboxyrhodamine 110 is completely consumed (The reaction is followed by TLC). This crude product is purified on a silica gel column using a gradient of chloroform/methanol.

### Example 6

### Preparation of Compound 6

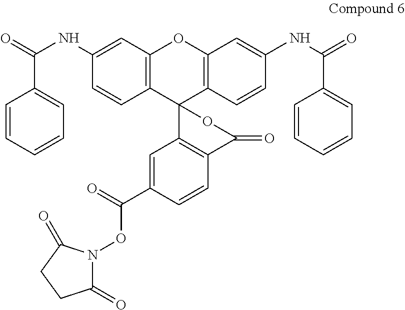

Compound 6 is prepared from the reaction of Compound 5 with N,N′-disuccinimidyl carbonate analogously to the procedure of Compound 2.

### Example 7

### Preparation of Compound 7

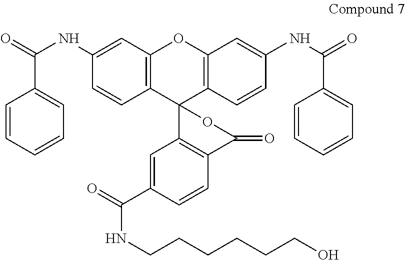

Compound 7 is prepared from the reaction of Compound 6 with 6-aminohexanol analogously to the procedure of Compound 3.

### Example 8

### Preparation of Compound 8

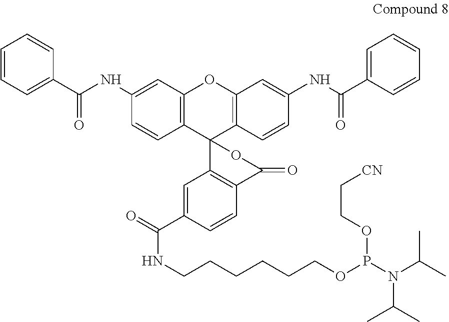

Compound 8 is prepared from the reaction of Compound 7 with bis-(N,N-diisopropyl)-beta-cyanoethyl phosphordiamidite analogously to the procedure of Compound 4.

### Example 9

### Preparation of Compound 9

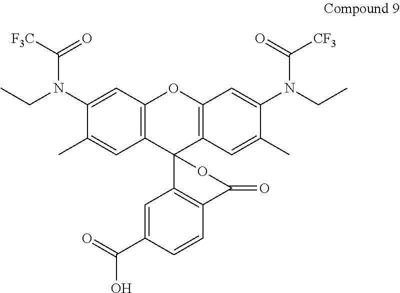

Compound 9 is prepared from the reaction of 6-carboxyrhodamine 6G with trifluoroacetic anhydride analogously to the procedure of Compound 1.

### Example 10

### Preparation of Compound 10

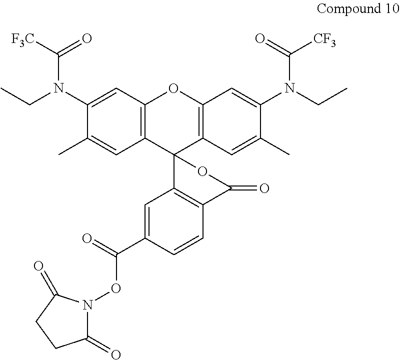

Compound 6 is prepared from the reaction of Compound 9 with N,N′-disuccinimidyl carbonate analogously to the procedure of Compound 2.

### Example 11

### Preparation of Compound 11

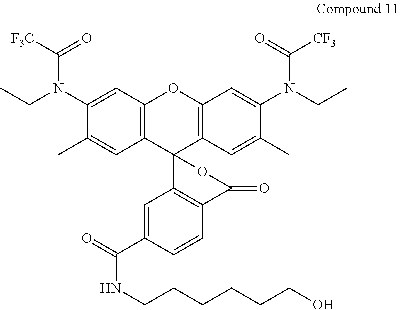

Compound 11 is prepared from the reaction of Compound 10 with 6-aminohexanol analogously to the procedure of Compound 3.

### Example 12

### Preparation of Compound 12

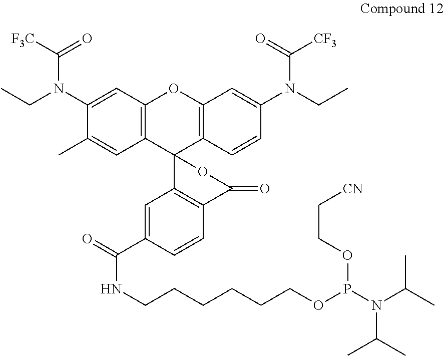

Compound 12 is prepared from the reaction of Compound 11 with bis-(N,N-diisopropyl)-beta-cyanoethyl phosphordiamidite analogously to the procedure of Compound 4.

### Example 13

### Preparation of Compound 13

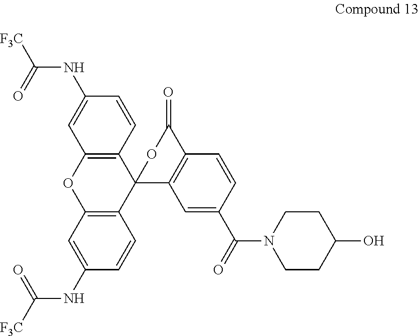

Compound 13 is prepared from the reaction of Compound 2 with 4-hydroxypiperidine analogously to the procedure of Compound 3.

### Example 14

### Preparation of Compound 14

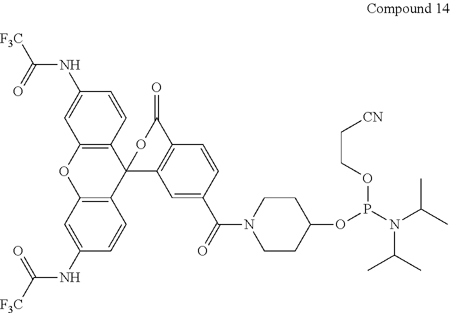

Compound 14 is prepared from the reaction of Compound 13 with bis-(N,N-diisopropyl)-beta-cyanoethyl phosphordiamidite analogously to the procedure of Compound 4.

### Example 15

### Preparation of Compound 15

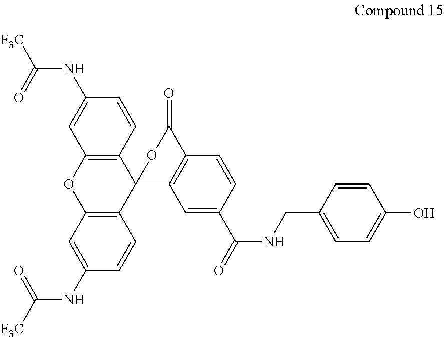

Compound 15 is prepared from the reaction of Compound 2 with 4-aminomethylphenol analogously to the procedure of Compound 3.

### Example 16

### Preparation of Compound 16

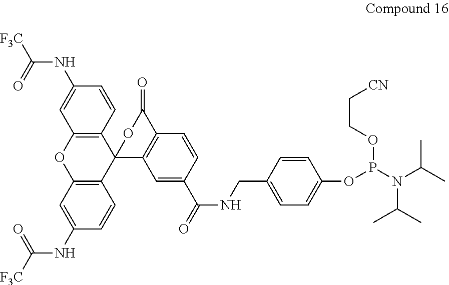

Compound 16 is prepared from the reaction of Compound 15 with bis-(N,N-diisopropyl)-beta-cyanoethyl phosphordiamidite analogously to the procedure of Compound 4.

### Example 17

### Preparation of Compound 17

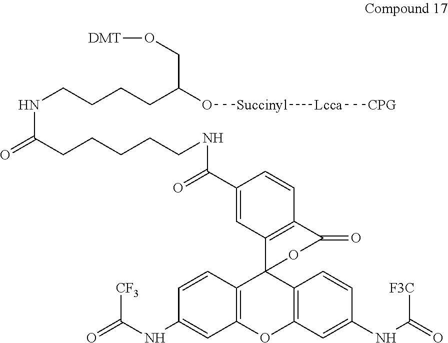

To a solution of N-FMOC-O-DMT-6-amino-1,2-hexanediol (3 g) and 4-dimethylaminopyridine (200 mg) in anhydrous pyridine (15 mL) is added succinic anhydride (300 mg). The reaction is stirred at room temperature overnight. The consumption of starting material is followed by TLC. The mixture is diluted in ethyl acetate (100 mL), washed with 0.5 M sodium chloride (3×100 mL) and saturated sodium chloride (100 mL), and dried over anhydrous sodium sulfate. After concentrating by rotary evaporation and drying under high vacuum, a yellow solid is obtained.

The yellow solid is dissolved in dry dioxane (10 mL) containing anhydrous pyridine (0.5 mL) and p-nitrophenol (350 mg). Dicyclohexylcarbodiimide (1.0 g) is added and the mixture is stirred at room temperature. The reaction is monitored by TLC and after 3 hours, the dicyclohexylurea is collected by filtration. Long chain alkylamine CPG (5.0 g) is suspended in the filtrate containing the p-nitrophenyl ester derivative, triethylamine (1.0 mL) is added, and the mixture is shaken overnight at room temperature. The derivatized support is copiously washed with dimethylformamide, methanol, and diethyl ester and dried in vacuo. Before capping the unreacted alkylamine groups, the loading capacity of the DMT-containing CPG is assayed by determining the amount of dimethoxytrityl cation released upon treatment with perchloric acid according to published procedures (Oligonucleotide Synthesis: A Practical Approach, M. J. Gait (ed.), IRL Press, Oxford, 1984).

Finally, the DMT-containing CPG is achieved by treatment with acetic anhydride-pyridine-DMAP (10:90:1. v/v/w) for one hour. The support is thoroughly washed with methanol and diethyl ether and dried under high vacuum to give the desired DMT-containing CPG. The capped CPG gives a negative ninhydrin test. The FMOC group of the capped CPG is then cleaved as described in the art (U.S. Pat. No. 5,401,837 to P. S. Paul, et al.). The FMOC-cleaved LCCA-CPG″ (5.0 g) is suspended in 10 mL of DMF solution containing Compound 2 (500 mg) and N,N-diisopropylethylamine (1.0 ml), and the mixture is shaken overnight at room temperature. The derivatized support is copiously washed with dimethylformamide, methanol, and diethyl ether and dried in vacuo. Before capping the unreacted alkylamine groups, the loading capacity of the dye-labeled CPG is assayed by determining the amount of dimethoxytrityl cation released upon treatment with perchloric acid according to published procedures (Oligonucleotide Synthesis: A Practical Approach, M. J. Gait (ed.), IRL Press, Oxford, 1984). Finally, capping of the dye-labeled CPG is achieved by treatment with acetic anhydride-pyridine-DMAP (10:90:1. v/v/w) for one hour. The support is thoroughly washed with methanol and diethyl ether and dried under high vacuum to give the dye-labeled CPG that give a negative ninhydrin test.

### Example 18

### Synthesis of a Rhodamine or Rhodol-Labeled Oligonucleotide

Oligonucleotide synthesis is performed using an automated DNA synthesizer according to manufacturer's instructions. Compound 4 or 12 is used to label oligonucleotides in this example. In each final coupling cycle, the Trityl ON configuration is used. After assembly, the oligonucleotides are cleaved from the support using concentrated ammonia using the manufacturer's end procedure cycle. The residue is dissolved in acetic acid/water (8:2) and the mixture is evaporated to dryness after 20 minutes at room temperature. To the residue is added water (0.5 ml) and the resultant suspension filtered. The aqueous solution now contains the deprotected oligonucleotide ready for purification.

Compound 4 or 12 (100 mg) is dissolved in 1 mL of dry acetonitrile and placed on the DNA synthesizer. Following the procedure suggested by the manufacturer, 50 μL of the solution of Compound 4 or 12 is delivered to the reaction column with 100 μL of a 0.5M tetrazole activator solution. The mixture is cycled over the support containing the 5′-OH oligonucleotide for a few minutes. Following the removal of excess Compound 4 or 12, the typical coupling cycle is completed by oxidation, capping, and detritylation. Labeled oligonucleotides (5 mer to 10 mer lengths) are released from the solid support and deprotected by treating with concentrated ammonium hydroxide for 20 minutes at 60° C. The rhodamine-labeled oligonucleotide are purified and analyzed by TLC (Kieselgel 60 F254 in 55:10:35 isopropanol:water:ammonia) or by reverse phase HPLC (gradient of 10-40% A in B over 30 minutes; A=acetonitrile, B=0.1M triethylammonium acetate, pH 7) or by polyacrylamide gel electrophoresis according to standard procedures (Sambrook, et al., Molecular Cloning: A Laboratory Manual, 2nd Edition, Cold Spring Harbor Laboratory Press, 1989).

A derivative such as DMT-5-Dye-deoxyuridine phosphoramidite (DMT-5-dye-dU-CEP) may be used to add a dye-labeled deoxyuridine (dU) residue to an oligonucleotide at the 5′ end or any point within the sequence between the 5′ and 3′ ends during the automated oligosynthesis. Usually, a researcher would substitute the dye-dU for a thymidine (dT) in the sequence so that the hybridization base pairing is not affected.

Additionally used derivatives are dye-deoxynucleotide triphosphate (dye-dNTP), dye-ribonucleotide triphosphate (dye-NTP), and dye-dideoxynucleotide triphosphate (dye-ddNTP) compounds. These reagents are useful to label DNA or RNA by enzymatic incorporation of the dye-linked dNTP or NTP. The dye-labeled dideoxynucleotide triphosphates (ddNTP) may be incorporated enzymatically into DNA for DNA sequencing applications as a chain terminator in the Sanger dideoxy sequencing method (Sanger, et al., J. Mol. Biol., 143, pp. 161-178, 1980). There is prior art for these compounds. Dye-ddATP, dye-ddCTP, dye-ddGTP, dye-ddTTP analogs are also contemplated.

What is claimed is:

1. A compound having Formula I: 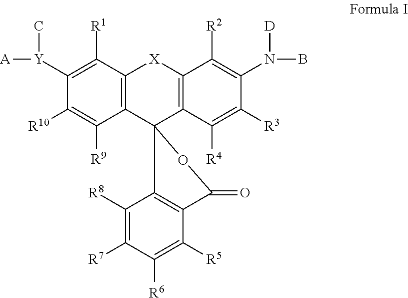
wherein A and B are independently C(═O)R¹¹, C(═O)NHR¹¹, C(═O)OR¹¹, or S(═O)₂R¹¹; C and D are independently none, a hydrogen, an alkyl, a halogenated alkyl, a cycloalkyl, an aryl, a heteroaryl, an arylalkyl, an alkoxyalkyl or a polyethyleneglycol (PEG); X is O, S, Se, NR¹³, CR¹³R¹⁴ or SiR¹³R¹⁴; Y is N or O; R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that at least one of C, D, R¹ to R¹⁰, R¹³ and R¹⁴ contains a phosphoramidite moiety as shown below: 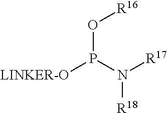
wherein LINKER is none or a covalent bond; R¹⁶ to R¹⁸ are independently an alkyl, a halogenated alkyl, a cyanoalkyl, a cycloalkyl, an arylalkyl, an alkoxyalkyl or a polyethyleneglycol (PEG).

2. The compound according to claim 1, wherein X is O and Y is N; LINKER is an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG).

3. The compound according to claim 1, wherein R⁶ or R⁷ contains a phosphoramidite moiety as shown below: 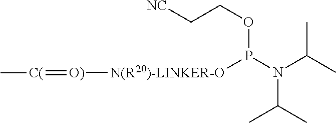
wherein LINKER is an alkyl, a cycloalkyl, aryl, heteroaryl or polyethyleneglycol (PEG); R²⁰ is a hydrogen, an alkyl, an aryl or a heteroaryl; R²⁰ and LINKER are optionally taken in combination to form a cycloalkyl or a hetero ring.

4. The compound according to claim 1, wherein R⁶ or R⁷ contains a phosphoramidite moiety as shown below: 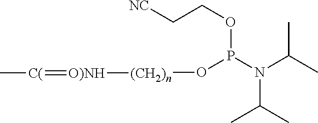
wherein n is 2 to 10.

5. A compound having Formula II: 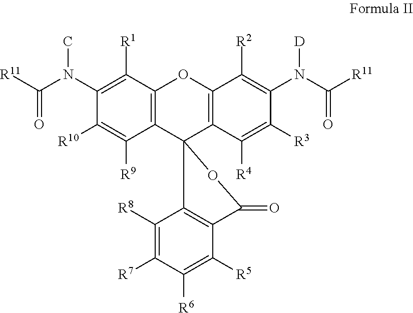
wherein C and D are independently a hydrogen, an alkyl, a cycloalkyl, an aryl, a heteroaryl, an arylalkyl, an alkoxyalkyl or a polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that R⁶ or R⁷ contains a phosphoramidite moiety as shown below: 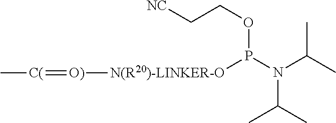
Wherein LINKER is an alkyl, a cycloalkyl, aryl, heteroaryl or polyethyleneglycol (PEG); R²⁰ is a hydrogen, an alkyl, an aryl or a heteroaryl; R²⁰ and LINKER are optionally taken in combination to form a cycloalkyl or a hetero ring.

6. The compound according to claim 5, wherein R¹¹ is CF₃.

7. The compound according to claim 5, wherein R⁶ or R⁷ contains a phosphoramidite moiety as shown below: 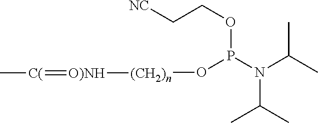
Wherein n is 2 to 10.

8. A compound having Formula III: 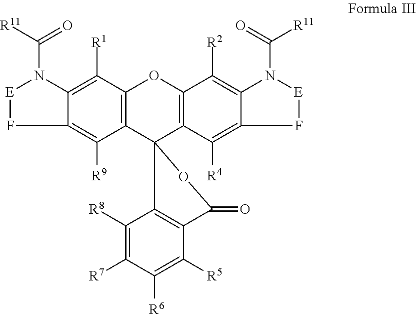
wherein E is a methylene or a dialkylmethylene; F is a methylene, an ethylene, a double bond, an aryl or a heteroaryl; R¹ to R⁹ are independently a hydrogen, an alkyl having 1-50 carbons, an alkoxy having 1-50 carbons, a trifluoromethyl, a halogen, a sulfonyl, a phosphonyl, a cyano, a carbonyl, a hydroxy, an amino, a thiol, an aryl, a heteroaryl; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that R⁶ or R⁷ contains a phosphoramidite moiety as shown below: 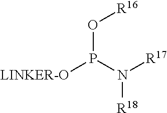
Wherein LINKER is none, an alkyl, a cycloalkyl, a carbonylalkyl, a carbonylaryl, a carbonylaminoalkyl, a carbonyloxyalkyl, a carbonylthioalkyl, a sulfonylalkyl, a sulfonylaminoalkyl, a phosphonylalkyl, a phosphonylaminoalkyl, a phosphonyloxyalkyl, an aryl, a heteroaryl or a polyethyleneglycol (PEG); R¹⁶ to R¹⁸ are independently an alkyl, a halogenated alkyl, a cyanoalkyl, a cycloalkyl, an arylalkyl, an alkoxyalkyl or a polyethyleneglycol (PEG).

9. The compound according to claim 8, wherein R¹¹ is CF₃.

10. The compound according to claim 8, wherein R⁶ or R⁷ contains a phosphoramidite moiety as shown below: 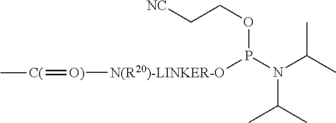
wherein LINKER is an alkyl, a cycloalkyl, aryl, heteroaryl or polyethyleneglycol (PEG); R²⁰ is a hydrogen, an alkyl, an aryl or a heteroaryl; R²⁰ and LINKER are optionally taken in combination to form a cycloalkyl or a hetero ring.

11. The compound according to claim 8, wherein R⁶ or R⁷ contains a phosphoramidite moiety as shown below: 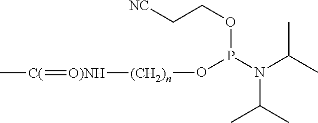
wherein n is 2 to 10.

12. A compound having Formula IV: 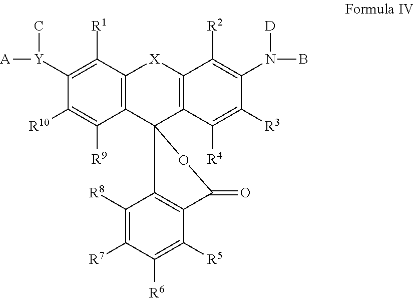
wherein A and B are independently C(═O)R¹¹, C(═O)NHR¹¹, C(═O)OR¹¹, or S(═O)₂R¹¹; C and D are independently none, a hydrogen, an alkyl, a halogenated alkyl, a cycloalkyl, an aryl, a heteroaryl, an arylalkyl, an alkoxyalkyl or a polyethyleneglycol (PEG); X is O, S, Se, NR¹³, CR¹³R¹⁴ or SiR¹³R¹⁴; Y is N or O; R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that at least one of C, D and R¹ to R¹² contains a polymer moiety.

13. The compound according to claim 12, wherein X is O; Y is N; POLYMER is a controlled pore glass (CPG) for synthesizing an oligonucleotide.

14. A compound having Formula V: 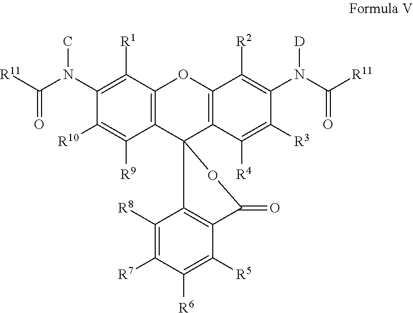
wherein C and D are independently a hydrogen, alkyl, cycloalkyl, arylalkyl, alkoxyalkyl or polyethyleneglycol (PEG); R¹ to R¹⁰ are independently a hydrogen, an alkyl having 1-50 carbons, an alkoxy having 1-50 carbons, a trifluoromethyl, a halogen, an alkylthio, a sulfonyl, a boronyl, a phosphonyl, a cyano, a carbonyl, a hydroxy, an amino, a thiol, an aryl, a heteroaryl; one or more of C and R¹, C and R¹⁰, D and R² or D and R³ are optionally taken in combination to form a cycloalkyl, a hetero ring, an aryl or a heteroaryl ring; R¹¹ is an alkyl, a halogenated alkyl, a perfluoroalkyl, a cycloalkyl, an arylalkyl, an alkoxyalkyl, a polyethyleneglycol (PEG), an aryl or a heteroaryl; provided that R⁶ or R⁷ contains a POLYMER moiety.

15. The compound according to claim 14, wherein POLYMER is a controlled pore glass (CPG) for synthesizing an oligonucleotide.
